(19) United States
(12) Patent Application Publication
(10) Pub. No.: US 2024/0345226 A1
(43) Pub. Date: Oct. 17, 2024

(54) DRIVE DEVICE, DISTANCE MEASUREMENT APPARATUS, AND LIGHT EMITTING APPARATUS

(71) Applicant: FUJIFILM Business Innovation Corp ., Tokyo (JP)

(72) Inventors: Daisuke IGUCHI, Kanagawa (JP); Junichiro HAYAKAWA, Kanagawa (JP); Kei TAKEYAMA, Kanagawa (JP)

(73) Assignee: FUJIFILM Business Innovation Corp ., Tokyo (JP)

(21) Appl. No.: 18/432,025

(22) Filed: Feb. 4, 2024

(30) Foreign Application Priority Data
Apr. 17, 2023 (JP) 2023-067229

(51) Int. Cl. G01S 7/484; G01S 7/4861

(52) U.S. Cl. CPC G01S 7/484; G01S 7/4861

(57) ABSTRACT

A drive device drives a light emitting device including a first light emitting section and a second light emitting section, in which each of the first light emitting section and the second light emitting section has predetermined plural light emitting periods, and the drive device is configured to: cause the light emitting device to perform pulse light emission 500 times or more in the light emitting period; and drive the light emitting device such that the second light emitting section has a light emitting period in a light non-emitting period during which the first light emitting section does not emit light between a light emitting period and a next light emitting period of the first light emitting section.

### CROSS-REFERENCE TO RELATED APPLICATIONS

This application is based on and claims priority under 35 USC 119 from Japanese Patent Application No. 2023-067229 filed Apr. 17, 2023.

### BACKGROUND

### (i) Technical Field

The present invention relates to a drive device, a distance measurement apparatus, and a light emitting apparatus.

### (ii) Related Art

There is a distance measurement apparatus that measures a distance to a target object by a so-called time of flight (ToF) method in which a time from emission of light to reception of the light reflected by the target object is measured (referred to as “distance measurement”).

For example, JP2020-153796A describes a distance measurement apparatus having a plurality of light emitting units, in which the light emitting units are divided into four groups of first to fourth groups, and control of selecting (switching) a group for light emission is executed in time-series.

### SUMMARY

In the distance measurement apparatus including the light emitting unit including a plurality of light emitting sections, in some cases, distance measurement is performed by providing a plurality of predetermined light emitting periods (may be referred to as “scheduled number”) per one light emitting section. In such a distance measurement apparatus, in a case where a light emitting period of another light emitting section is provided after the scheduled number of light emitting periods in a certain light emitting section, for example, in a case where an interval between the light emitting periods is increased to reduce an influence of heat generation associated with the light emission, it takes a long time to complete the scheduled number of light emitting periods in all the light emitting sections.

Aspects of non-limiting embodiments of the present disclosure relate to a drive device, a distance measurement apparatus, and a light emitting device that reduce a time until the scheduled number of light emitting periods are completed in all light emitting sections, as compared with a case where a light emitting period of another light emitting section is provided after the scheduled number of light emitting periods while keeping a long interval between the light emitting periods in a certain light emitting section.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a drive device that drives a light emitting device including a first light emitting section and a second light emitting section, in which each of the first light emitting section and the second light emitting section has a predetermined plurality of light emitting periods, and the drive device is configured to: cause the light emitting device to perform pulse light emission 500 times or more in the light emitting period; and drive the light emitting device such that the second light emitting section has a light emitting period in a light non-emitting period during which the first light emitting section does not emit light between a light emitting period and a next light emitting period of the first light emitting section.

### BRIEF DESCRIPTION OF THE DRAWINGS

Exemplary embodiment(s) of the present invention will be described in detail based on the following figures, wherein:

FIG. 1 is a block diagram illustrating an example of a schematic configuration of a distance measurement apparatus according to the present exemplary embodiment;

FIG. 2 is a diagram illustrating a relationship between a light emitting surface of a light emitting unit according to the present exemplary embodiment and an irradiation surface irradiated with light emitted from the light emitting unit;

FIG. 3 is a diagram illustrating an example of the light emitting unit according to the present exemplary embodiment;

FIG. 4 is a diagram illustrating a relationship between a light receiving surface of a light receiving unit according to the present exemplary embodiment and the irradiation surface described above;

FIGS. 5A and 5C are diagrams describing a distance image according to the present exemplary embodiment, FIG. 5A is a diagram illustrating a positional relationship between a distance measurement apparatus and a target object, FIG. 5B is a diagram illustrating a state of an irradiation surface, and FIG. 5C is a diagram illustrating an example of the distance image created by a control unit;

FIG. 6 is a diagram illustrating an operation pattern according to a comparative example;

FIG. 7 is a diagram illustrating a first operation pattern of the distance measurement apparatus to which the present exemplary embodiment is applied;

FIG. 8 is a diagram illustrating a second operation pattern of the distance measurement apparatus to which the present exemplary embodiment is applied;

FIG. 9 is a diagram illustrating a third operation pattern of the distance measurement apparatus to which the present exemplary embodiment is applied;

FIG. 10 is a diagram illustrating a fourth operation pattern of the distance measurement apparatus to which the present exemplary embodiment is applied;

FIG. 11 is a diagram illustrating a modification example of the second operation pattern;

FIG. 12 is a diagram illustrating another modification example of the second operation pattern;

FIG. 13 is a diagram illustrating a fifth operation pattern of the distance measurement apparatus to which the present exemplary embodiment is applied;

FIG. 14 is a diagram illustrating a sixth operation pattern of the distance measurement apparatus to which the present exemplary embodiment is applied; and

FIGS. 15A and 15B are diagrams illustrating an example of a light emitting operation in one light emitting period of each light emitting section.

### DETAILED DESCRIPTION

Hereinafter, exemplary embodiments of the present invention will be described in detail with reference to the accompanying drawings.

The technical scope of the present invention is not limited to the scope to be described below as an exemplary embodiment. It is clear from the description of the claims that a combination of a plurality of examples and various modifications or improvements to the exemplary embodiment described above are also included in the technical scope of the present invention.

### Distance Measurement Apparatus 1

### Overall Configuration

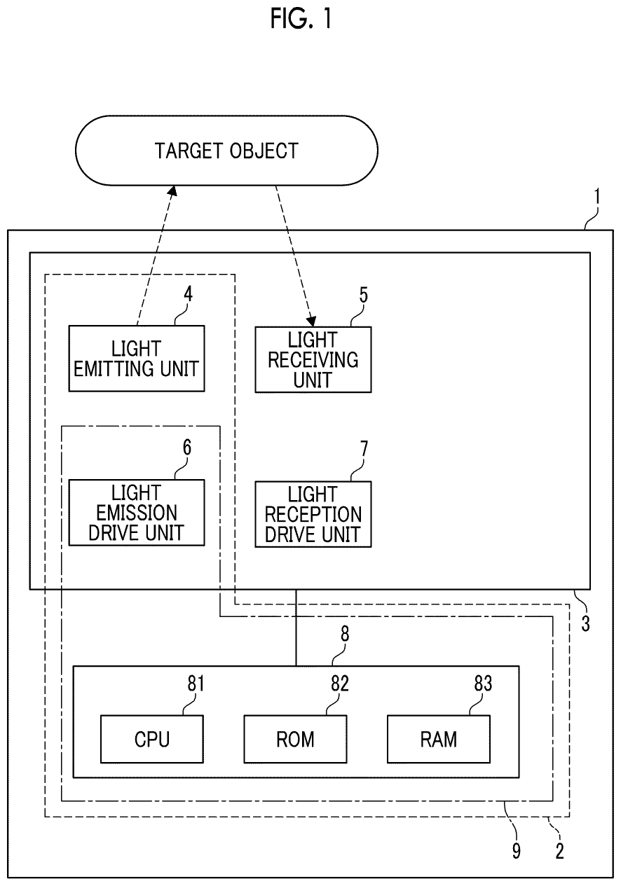

FIG. 1 is a block diagram illustrating an example of a schematic configuration of a distance measurement apparatus 1 according to the present exemplary embodiment.

The distance measurement apparatus 1 measures a distance to a target object based on a time from a timing at which light is emitted from a light emitting unit 4 to a timing at which the light reflected by the target object is received by the light receiving unit 5. That is, the distance measurement apparatus 1 is a device that performs distance measurement based on a ToF method. The ToF method includes an indirect ToF (iToF) method in which a time is measured from a difference between a phase of emitted light and a phase of received light, and a direct ToF (dToF) method in which a time from emission to reception of light is directly measured. In the present exemplary embodiment, the distance measurement apparatus 1 is assumed to perform distance measurement based on the indirect ToF method.

As illustrated in FIG. 1, the distance measurement apparatus 1 includes an optical device 3 and a control unit 8.

The optical device 3 includes a light emitting unit 4 that emits light toward a predetermined irradiation range, a light receiving unit 5 that receives the light emitted from the light emitting unit 4 and reflected by a target object existing in the irradiation range, a light emission drive unit 6 that drives the light emitting unit 4, and a light reception drive unit 7 that drives the light receiving unit 5.

Details of the configurations of the light emitting unit 4 and the light receiving unit 5 of the optical device 3 will be described below. In addition, reference numeral 2 indicated by a broken line and reference numeral 9 indicated by a one-dot chain line will be described below.

The control unit 8 controls the operations of the light emitting unit 4 and the light receiving unit 5 of the optical device 3.

In addition, the control unit 8 acquires a result of the light reception by the light receiving unit 5, and calculates a distance from the distance measurement apparatus 1 to the target object by the ToF method based on the result of the light reception.

The control unit 8 is an example of a calculation unit that calculates the distance to the target object based on the result of the light reception.

### Light Emitting Unit 4

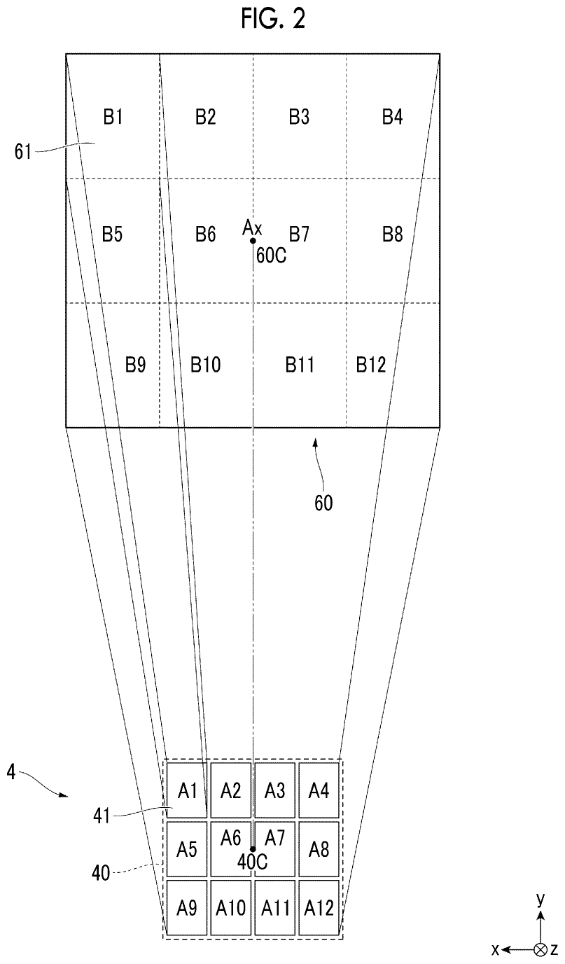

FIG. 2 is a diagram illustrating a relationship between a light emitting surface 40 of the light emitting unit 4 according to the present exemplary embodiment and an irradiation surface 60 irradiated with light emitted from the light emitting unit 4. A left direction of the page plane of FIG. 2 is a +x direction, an upward direction of the page plane of FIG. 2 is a +y direction, a back side direction of the page plane of FIG. 2 is a +z direction, and each opposite directions are −x, −y, and −z directions. Although the light emitting surface 40 and the irradiation surface 60 are illustrated to deviate in an up-down direction (+y direction) of the page plane of FIG. 2, the light emitting surface 40 and the irradiation surface 60 are actually disposed to face each other. The light emitting surface 40 of the light emitting unit 4 is located in a front side direction (−z direction) of the page plane of FIG. 2, and the irradiation surface 60 is located in a back side direction (+z direction) of the page plane of FIG. 2. That is, FIG. 2 illustrates a state of the light emitting unit 4 that emits light to the irradiation surface 60 as viewed from a side opposite to a side on which the light emitting unit 4 emits the light.

The light emitting unit 4 is configured with, for example, one or a plurality of light emitting chips. The light emitting unit 4 is an example of a light emitting device.

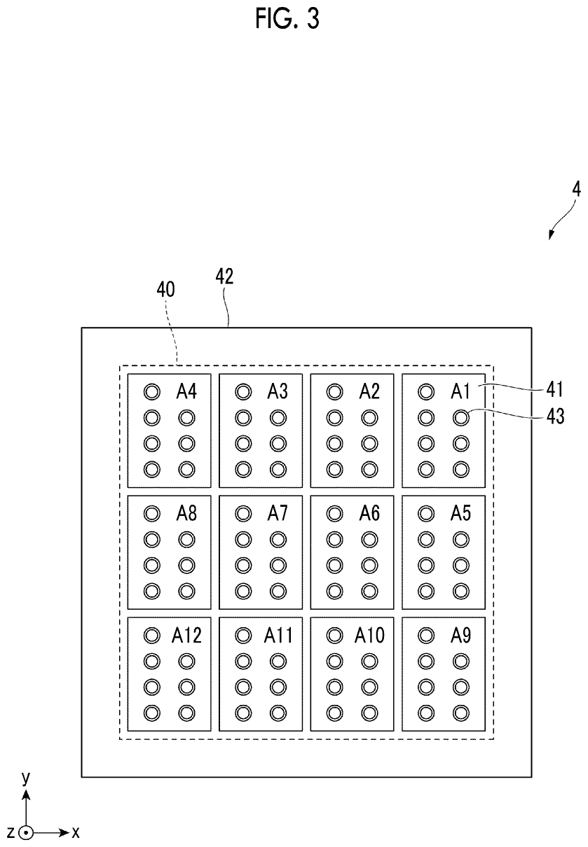

The light emitting unit 4 includes the light emitting surface 40 on which a plurality of vertical cavity surface emitting lasers (VCSELs, referred to by reference numeral 43 in FIG. 3 to be described below) are arranged. The light emitting unit 4 emits light toward the irradiation surface 60 by light emission of the VCSEL. The VCSEL is an example of a light emitting element. In FIG. 2, the VCSEL is not illustrated.

The light emitting surface 40 is divided into a plurality of light emitting sections 41 including at least one VCSEL. Here, as an example, the light emitting surface 40 is divided into 12 light emitting sections 41 in a total of four light emitting sections 41 in the x-direction and three light emitting sections 41 in the y-direction. As illustrated in FIG. 2, in a case where it is necessary to distinguish the light emitting sections 41 from each other, the light emitting sections 41 are distinguished as light emitting sections A1 to A12 in order from the upper left side (ends in the +x direction and the +y direction) in FIG. 2.

In the present specification, the term “to” indicates a plurality of components distinguished individually by numbers, and means that components before and after “to” and components having numbers between the components are included. For example, the light emitting sections A1 to A12 include 12 light emitting sections 41 from the light emitting section A1 to the light emitting section A12 in numerical order.

Each light emitting section 41 is independently driven by the light emission drive unit 6 (see FIG. 1) to perform a light emitting operation. The driving of the light emitting section 41 means that power is supplied to the VCSEL included in the light emitting section 41 to emit light, and the light emitting operation means that the VCSEL included in the light emitting section 41 emits the light for a predetermined light emitting period. The term “independently driven” indicates that each light emitting section 41 is driven to enter a state for emitting the light. The light emission drive unit 6 drives each light emitting section 41 in response to a control signal from the control unit 8 (see FIG. 1).

Thus, each light emitting section 41 does not always emit the light simultaneously, and for example, may be in a state in which, while the light emitting section A1 emits light, the light emitting section A12 does not emit light, as illustrated in FIG. 2.

The irradiation surface 60 is a surface that is perpendicular to a direction (+z direction) in which light is emitted at a certain distance from a center 40C of the light emitting surface 40, and irradiated with the light from the light emitting unit 4.

In the example in FIG. 2, the light emitting unit 4 emits light in the +z direction. Thus, the irradiation surface 60 extends in the x-direction and the y-direction at a certain distance in the +z direction. A central axis Ax (two-dot chain line) passing through a center 60C of the irradiation surface 60 and the center 40C of the light emitting surface 40 is perpendicular to the light emitting surface 40 and the irradiation surface 60. In the present exemplary embodiment, as the light emitting surface 40 has a rectangular shape, the irradiation surface 60 has a rectangular shape.

As illustrated in FIG. 2, the irradiation surface 60 is divided into a plurality of irradiation sections 61 corresponding to the light emitting sections 41 in the light emitting surface 40. In the example of FIG. 2, the irradiation surface 60 is divided into 12 irradiation sections 61 of four irradiation sections 61 in the x-direction and three irradiation sections 61 in the y-direction. In a case where it is necessary to distinguish the irradiation sections 61 from each other, irradiation sections B1 to B12 are referred to in order from the upper left side (ends in the +x direction and the +y direction) in FIG. 2.

A light emitting section Ai to which the same number i as a number of a certain irradiation section Bi is assigned may be referred to as a “corresponding light emitting section”. For example, the light emitting section A1 is a light emitting section corresponding to the irradiation section B1. On the contrary, an irradiation section Bi to which the same number i as a number of a certain light emitting section Ai is assigned may be referred to as a “corresponding irradiation section”.

The irradiation sections B1 to B12 have a plane-symmetrical arrangement to the light emitting sections A1 to A12 based on an xy plane. For example, in FIG. 2, as the irradiation sections B1, B2, B3, and B4 are arranged in this order in the −x direction, the light emitting sections A1, A2, A3, and A4 are arranged in this order in the −x direction.

Each light emitting section 41 emits light toward the corresponding irradiation section 61. Each irradiation section 61 is irradiated with the light emitted from the corresponding light emitting section 41. Here, the fact that the light emitting section 41 emits the light toward the corresponding irradiation section 61 means that an optical axis of the light emitted from each light emitting section 41 faces the corresponding irradiation section 61, and all of the light emitted from the light emitting section 41 is not limited to being emitted onto the corresponding irradiation section 61. In other words, in some cases, a part of the light emitted from a certain light emitting section 41 may be emitted onto the irradiation section 61 different from the corresponding irradiation section 61 or outside a range of the irradiation surface 60.

FIG. 3 is a diagram illustrating an example of the light emitting unit 4 according to the present exemplary embodiment. FIG. 3 illustrates a state of the light emitting unit 4 as viewed from a light emission side, contrary to FIG. 2. Accordingly, a right direction of the page plane of FIG. 3 is the +x direction, an upward direction of the page plane of FIG. 3 is the +y direction, and a front direction of the page plane of FIG. 3 is the +z direction.

As illustrated in FIG. 3, the light emitting unit 4 has a substrate 42, and the light emitting surface 40 on which a plurality of VCSELs 43 are disposed. In more detail, the substrate 42 and the light emitting surface 40 are provided to overlap with each other in a direction (the +z direction or the front direction of the page plane of FIG. 3) in which light is emitted. In addition to wiring for supplying power or exchanging electric signals, electronic components related to the operation of the light emitting unit 4 may be formed or attached on the substrate 42, and the description thereof will be omitted.

As described above, the light emitting unit 4 includes the 12 light emitting sections 41 (light emitting sections A1 to A12) in which the VCSELs 43 are arranged on the light emitting surface 40. As illustrated in FIG. 3, the light emitting sections A1 to A12 all have the same area. In addition, the same number (7 in this example) of VCSELs 43 are arranged in each of the light emitting sections A1 to A12.

The area of each light emitting section 41 and the number of VCSELs 43 to be arranged are not limited, and some or all of the light emitting sections 41 may have different areas from each other, and different numbers of VCSELs 43 may be arranged at some or all of the light emitting sections 41.

The light emitted from each light emitting section 41 of the light emitting unit 4 is spread with a plane perpendicular to the emission direction (the axial direction of the central axis Ax) by a diffusion unit (not illustrated) and is emitted to the irradiation surface 60. As the diffusion unit, an optical member such as a diffusion plate that is provided on an optical path of the light to diffuse the light with scattering or the like, and a diffractive optical element (DOE) or/and a lens that changes an angle of the incident light and emits the light can be used.

### Light Receiving Unit 5

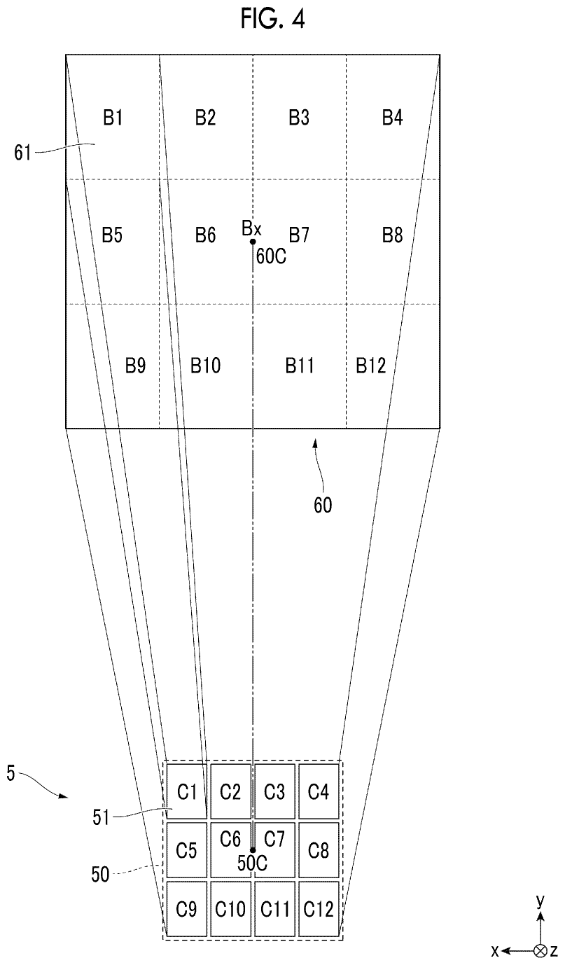

FIG. 4 is a diagram illustrating a relationship between a light receiving surface 50 of the light receiving unit 5 according to the present exemplary embodiment and the irradiation surface 60 described above. In the same manner as FIG. 2, a left direction of the page plane of FIG. 4 is a +x direction, an upward direction of the page plane of FIG. 4 is a +y direction, a back side direction of the page plane of FIG. 4 is a +z direction, and each opposite directions are −x, −y, and −z directions. Although the light receiving surface 50 and the irradiation surface 60 are illustrated to deviate in the up-down direction (+y direction) of the page plane of FIG. 4, the light receiving surface 50 and the irradiation surface 60 are actually disposed to face each other. The light receiving unit 5 (light receiving surface 50) is located in the front side direction (−z direction) of the page plane of FIG. 4, and the irradiation surface 60 is located in the back side direction (+z direction) of the page plane of FIG. 4. That is, FIG. 4 illustrates a state of the light receiving unit 5 that receives light reflected from the irradiation surface 60 as viewed from a side opposite to a side on which the light receiving unit 5 receives the light.

The light receiving unit 5 extends in the x-direction and the y-direction, and includes the light receiving surface 50 in which a plurality of light receiving elements (not illustrated) are arranged. The light receiving unit 5 receives the light emitted from the light emitting unit 4 and reflected by a target object existing at the irradiation surface 60, by each light receiving element.

A central axis Bx (two-dot chain line) passing through the center 60C of the irradiation surface 60 and a center 50C of the light receiving surface 50 is perpendicular to the irradiation surface 60 and the light receiving surface 50. In the present exemplary embodiment, in the same manner as the light emitting surface 40 (see FIG. 2) and the irradiation surface 60, the light receiving surface 50 has a rectangular shape.

The light receiving surface 50 is divided into a plurality of light receiving sections 51 corresponding to the light emitting sections 41 (see FIG. 2) of the light emitting surface 40 (see FIG. 2) and the irradiation sections 61 of the irradiation surface 60. In the example of FIG. 4, the light receiving surface 50 is divided into 12 light receiving sections 51 of four light receiving sections 51 in the x-direction and three light receiving sections 51 in the y-direction. In a case where it is necessary to distinguish the light receiving sections 51 from each other, the light receiving sections 51 are distinguished as light receiving sections C1 to C12 in order from the upper left side (ends in the +x direction and +y direction) in FIG. 4.

A light receiving section Ci to which the same number i as a number of a certain light emitting section Ai and a certain irradiation section Bi is assigned may be referred to as a “corresponding light receiving section”. For example, the light receiving section C1 is a light receiving section corresponding to the light emitting section A1 or the irradiation section B1. On the contrary, the light emitting section Ai to which the same number as a number of a certain light receiving section Ci is assigned is referred to as a “corresponding light emitting section”, and the irradiation section Bi to which the same number as a number of a certain light receiving section Ci is assigned is referred to as “corresponding irradiation section”, in some cases.

The light receiving sections C1 to C12 have a plane-symmetrical arrangement to the irradiation sections B1 to B12 based on the xy plane. For example, in FIG. 4, as the irradiation sections B1, B2, B3, and B4 are arranged in this order in the −x direction, the light receiving sections C1, C2, C3, and C4 are arranged in this order in the −x direction.

Each light receiving section 51 receives light emitted from the light emitting unit 4 and reflected by a target object existing at the corresponding irradiation section 61.

Each light receiving section 51 has a plurality of light receiving elements that are regularly arranged. Each light receiving element can receive light emitted from the light emitting unit 4 and reflected by a target object existing at the irradiation surface 60, and can output an electric signal in response to the received light. Examples of the light receiving element include a photodiode or a phototransistor.

Each light receiving section 51 is independently driven by the light reception drive unit 7 (see FIG. 1) to perform a light receiving operation. Here, the drive of the light receiving section 51 means that the light receiving section 51 is in a state capable of accumulating a charge corresponding to the light reception of the light receiving element, and the light receiving operation means that the light receiving element of the light receiving section 51 accumulates the charge in response to the light reception. In addition, the term “independently driven” indicates that each light receiving section 51 is driven to enter a state in which the charge can be accumulated in response to the light reception. The light reception drive unit 7 drives each light receiving section 51 in response to a control signal from the control unit 8 (see FIG. 1).

In addition, the light receiving unit 5 outputs an electric signal corresponding to the charge accumulated in the light receiving section 51, that is, a result of the light received in the light receiving section 51 to the control unit 8, in accordance with a read operation of the control unit 8 (details will be described below).

### Control Unit 8

With reference to FIG. 1, the control unit 8 is configured with a central processing unit (CPU) 81, a read only memory (ROM) 82, a random access memory (RAM) 83.

The CPU 81 is an example of a processor, and implements each function, which will be described below, by loading various programs stored in the ROM 82 or the like into the RAM 83 and executing the programs. The RAM 83 is a memory used as a work memory or the like of the CPU 81. The ROM 82 is a memory which stores various programs and the like executed by the CPU 81.

Here, the program executed by the CPU 81 may be provided in a state of being stored in a computer-readable recording medium such as a magnetic recording medium (a magnetic tape, a magnetic disk, or the like), an optical recording medium (an optical disk or the like), a magnetooptical recording medium, or a semiconductor memory. The program executed by the CPU 81 may be provided by using a communication section such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The control unit 8 controls the light emitting operation of the light emitting unit 4 through the light emission drive unit 6, and controls the light receiving operation of the light receiving unit 5 through the light reception drive unit 7.

In addition, the control unit 8 performs a read operation on the light receiving unit 5 through the light reception drive unit 7. Here, the term “read operation” means that the control unit 8 controls the light receiving unit 5 through the light reception drive unit 7 and causes the light receiving unit 5 to output an electric signal corresponding to a result of light reception by the light receiving element in the light receiving section 51, and acquires the electric signal as the result of the light reception for each light receiving section 51. The control unit 8 according to the present exemplary embodiment can independently perform the read operation for each light receiving section 51. For example, in a case where a certain light receiving section Ci and another light receiving section Cj perform a light receiving operation to accumulate a charge, not only a read operation can be performed on both the light receiving section Ci and the light receiving section Cj but also the read operation can be performed on only the light receiving section Ci.

Meanwhile, in general, in the indirect ToF method, light is received with a plurality of phase differences with respect to emission of light, and a difference between the phase of the emitted light and the phase of the received light is obtained from the result of the light reception at each phase difference to measure a distance. Further, in general, in order to reduce a decrease in distance measurement accuracy by external light (ambient light), light reception is performed a plurality of times for one phase difference. Therefore, in a case where light reception is performed k times at each of n phase differences φ (φ1, φ2, . . . , and φn), emission of light, reception of the light at a certain phase difference q, and reading of a result of the light reception are repeated n×k times.

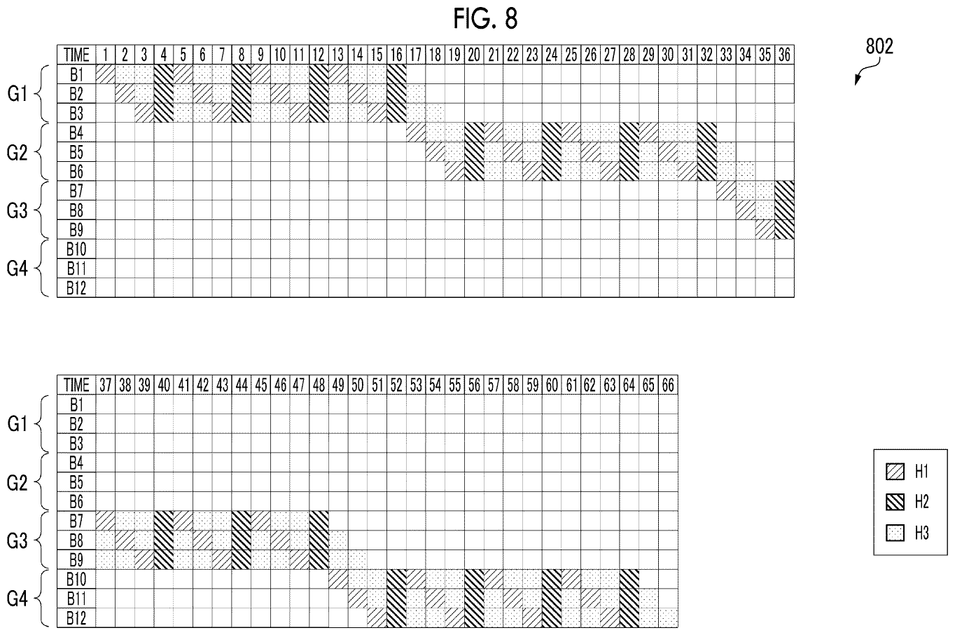

In the distance measurement apparatus 1 to which the present exemplary embodiment is applied, a distance is measured based on the indirect ToF method, from a result of performing light reception twice at each of two phase differences φ of 0 degrees and 180 degrees with respect to emission of light. Thus, in a case of performing distance measurement of, for example, a certain irradiation section Bi in the distance measurement apparatus 1, a light emitting operation in the corresponding light emitting section Ai, a light receiving operation in the corresponding light receiving section Ci, and a read operation for the light receiving section Ci by the control unit 8 are respectively repeated four times. More specifically, in the distance measurement apparatus 1, four light emitting operations in each light emitting section 41, four light receiving operations in each light receiving section 51, and four read operations for each light receiving section 51 are performed according to a predetermined operation pattern. Details of the predetermined operation pattern will be described below with reference to FIG. 8.

The control unit 8 performs distance measurement of each irradiation section 61, based on a result of light reception in each light receiving section 51. The results of distance measurement in each irradiation section 61 are collected, and a distance image representing the distance between the distance measurement apparatus 1 and the target object is created. More specifically, the control unit 8 calculates (performs distance measurement) a distance between the distance measurement apparatus 1 and the target object in each irradiation section 61 of the irradiation surface 60 by performing a predetermined arithmetic process on four electric signals acquired from the light receiving unit 5 as a result of the four light receptions in each light receiving section 51, and creates a distance image.

### Distance Image 100

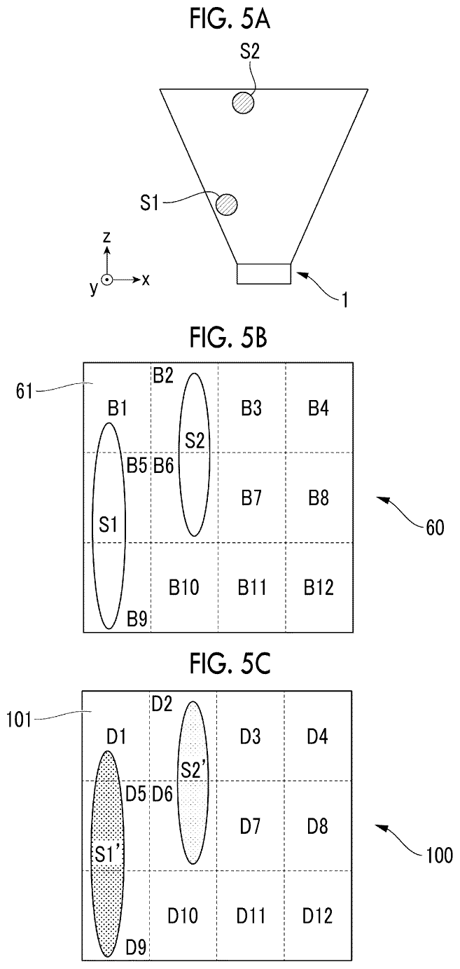

FIGS. 5A and 5C are diagrams describing a distance image 100 according to the present exemplary embodiment, FIG. 5A is a diagram illustrating a positional relationship between the distance measurement apparatus 1 and target objects S1 and S2, FIG. 5B is a diagram illustrating a state of the irradiation surface 60, and FIG. 5C is a diagram illustrating an example of the distance image 100 created by the control unit 8.

The distance image 100 illustrated in FIG. 5C is created as a result of performing distance measurement on all the irradiation sections 61 of the irradiation surface 60. In the example of FIG. 5, it is assumed that the target objects S1 and S2 (may be referred to as a target object S without distinguishing the target objects S1 and S2) are stopped at least from a start to an end of distance measurement required for creating the distance image 100 by the distance measurement apparatus 1 and a position with respect to the distance measurement apparatus 1 is not changed.

As illustrated in FIG. 5C, the distance image 100 has a plurality of image sections 101 corresponding to the light emitting sections 41 of the light emitting surface 40, the irradiation sections 61 of the irradiation surface 60, and the light receiving sections 51 of the light receiving surface 50 (see FIGS. 2 and 4). In the example of FIG. 5C, the distance image 100 has 12 image sections 101 of four image sections 101 arranged in the right-left direction of FIG. 5C corresponding to the ±x direction of the irradiation surface 60 and the light receiving surface 50, and three image sections 101 arranged in the up-down direction of FIG. 5C corresponding to the ±y direction. In a case where it is necessary to distinguish the image sections 101 from each other, image sections D1 to D12 are distinguished in order from the upper left side in FIG. 5C.

An image section Di in the distance image 100 is an image obtained based on light emitted by the light emitting section Ai of the light emitting surface 40, reflected by the target object at the irradiation section Bi of the irradiation surface 60, and received in the light receiving section Ci of the light receiving surface 50. The image section Di to which the same number i as a number of the light emitting section Ai, the irradiation section Bi, and the light receiving section Ci is assigned may be referred to as a “corresponding image section”. On the contrary, in some cases, the light emitting section Ai to which the same number i as a number of the image section Di is assigned is referred to as a “corresponding light emitting section”, the irradiation section Bi to which the same number i as a number of the image section Di is assigned is referred to as a “corresponding irradiation section”, and the light receiving section Ci to which the same number i as a number of the image section Di is assigned is referred to as a “corresponding light receiving section”.

Each image section 101 of the distance image 100 has a plurality of pixels (not illustrated) associated with the plurality of light receiving elements included in the corresponding light receiving section 51. In the distance image 100, a pixel value of each pixel of the image section 101 corresponds to a distance from the distance measurement apparatus 1 to the target object, which is calculated from the electric signal from each light receiving element of the light receiving section 51.

In the example illustrated in FIG. 5A, the target objects S1 and S2 exist at positions separated from the distance measurement apparatus 1 by a certain distance. As illustrated in FIG. 5B, the target object S1 in this example exists in a range across the irradiation sections B1, B5, and B9 of the irradiation surface 60, and the target object S2 exists in a range across the irradiation sections B2 and B6. Further, a distance from the distance measurement apparatus 1 to the target object S1 (for example, approximately 1 m) is smaller than a distance from the distance measurement apparatus 1 to the target object S2 (for example, approximately 3 m).

As illustrated in FIG. 5C, in the distance image 100, an image S1′ representing the target object S1 and an image S2′ representing the target object S2 (may be referred to as an image S′ without distinguishing the image S1′ and the image S2′) are illustrated by pixels included in each image section 101. More specifically, the image S1′ is illustrated across the image sections D1, D5, and D9 corresponding to the irradiation sections B1, B5, and B9 in the distance image 100, and the image S2′ is illustrated across the image sections D2 and D6 corresponding to the irradiation sections B2 and B6 in the distance image 100.

In this example, information on a distance from the distance measurement apparatus 1 to the target object S1 and a distance from the distance measurement apparatus 1 to the target object S2 can be obtained by pixel values (represented by shading in FIG. 5C) of pixels constituting the image S1′ and the image S2′ in the distance image 100.

Since the distance image 100 includes information on a distance between each point on a surface of the target object S and the distance measurement apparatus 1, the distance image 100 may be considered to include information on a three-dimensional shape of the target object S. Thus, the distance measurement apparatus 1 to which the present exemplary embodiment is applied can also be used for three-dimensional measurement.

### Operation Pattern

Meanwhile, in a case where a light emitting operation is performed four times on each light emitting section 41 of the light emitting unit 4 as in the distance measurement apparatus 1, four light emitting periods are provided. The four light emitting periods are an example of a predetermined plurality of (scheduled number of) light emitting periods in the present exemplary embodiment.

In such a distance measurement apparatus, in a case where a light emitting period of another light emitting section Aj is provided after four light emitting periods in a certain light emitting section Ai, for example, in a case where an interval between the light emitting periods of the light emitting section Ai is set to be long to reduce an influence of heat generation (details will be described below) associated with light emission, it takes a long time to complete the four light emitting periods in all the light emitting sections 41.

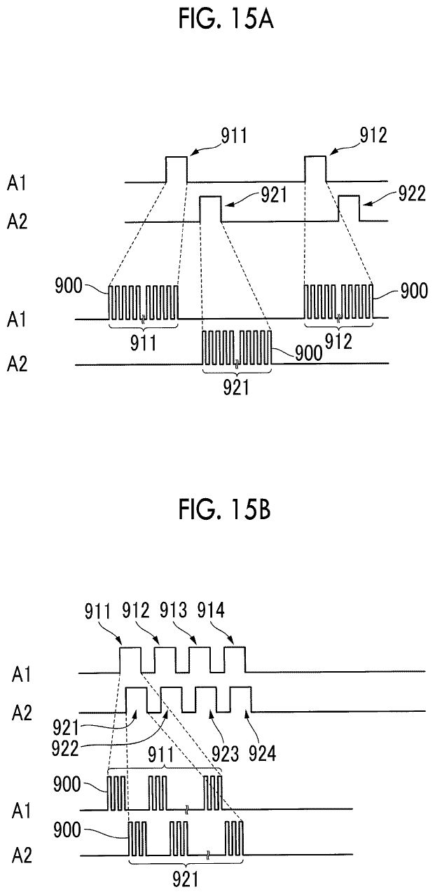

Here, the light emitting operation of the light emitting section 41 within the light emitting period will be described in more detail with reference to FIGS. 15A and 15B. FIGS. 15A and 15B are diagrams illustrating an example of a light emitting operation in one light emitting period of each light emitting section 41 (see FIGS. 2 and 3). FIGS. 15A and 15B illustrate an example of a light emitting operation by two light emitting sections A1 and A2 among the plurality of light emitting sections 41.

As the light emitting operation, each light emitting section 41 according to the present exemplary embodiment is driven by the light emission drive unit 6 (see FIG. 1) and causes a VCSEL to perform pulse light emission a large number of times during a light emitting period for light emission such that the corresponding irradiation section 61 is irradiated with the light. More specifically, as illustrated in FIGS. 15A and 15B, each of the light emitting periods (indicated by reference numerals 911 to 914) of the light emitting section A1 is configured with a large number of times of pulse 900. In the same manner, each of the light emitting periods (indicated by reference numerals 921 to 924) of the light emitting section A2 is configured with a large number of times of pulse 900. The number of times of the pulse 900 constituting one light emitting period varies depending on a length of the light emitting period and a width of the pulse 900, and can be, for example, approximately several tens to several hundred times. The light emitting section 41 according to the present exemplary embodiment performs pulse light emission 10,000 times within one light emitting period. The number of times of pulse light emission may be changed depending on accuracy of distance measurement required for the distance measurement apparatus 1, performance of the device, or the like, and may be, for example, at least 500 times or more.

For example, as illustrated in FIG. 15A, each light emitting section 41 can perform the light emitting operation such that the light emitting period (for example, the light emitting period 921) of another light emitting section 41 (for example, the light emitting section A2) is included between the light emitting periods (for example, light emitting periods 911 and 912) of one light emitting section 41 (for example, the light emitting section A1). Further, for example, in each light emitting section 41, as illustrated in FIG. 15B, the light emitting operation can be performed such that the pulse 900 constituting the light emitting period (light emitting period 921) of another light emitting section 41 (light emitting section A2) is included between the pulses 900 constituting the light emitting period (light emitting period 911) of one light emitting section 41 (light emitting section A1).

Hereinafter, an operation pattern of a comparative example to which the present exemplary embodiment is not applied and an operation pattern of the distance measurement apparatus 1 to which the present exemplary embodiment is applied will be described by using a case in which a light emitting period of each light emitting section 41 is 500 μs (microseconds) as an example. That is, as the light emitting operation, each light emitting section 41 is driven by the light emission drive unit 6 (see FIG. 1) and causes the VCSEL to emit light for 500 μs such that the corresponding irradiation section 61 is irradiated with the light. More specifically, as described above with reference to FIGS. 15A and 15B, the light emitting section 41 according to the present exemplary embodiment performs pulse light emission 10,000 times during one light emitting period of 500 μs, and emits the light onto the corresponding irradiation section 61. The light emitting period is not limited to 500 μs, and is determined in advance according to the amount of light or the like required to secure the accuracy of distance measurement.

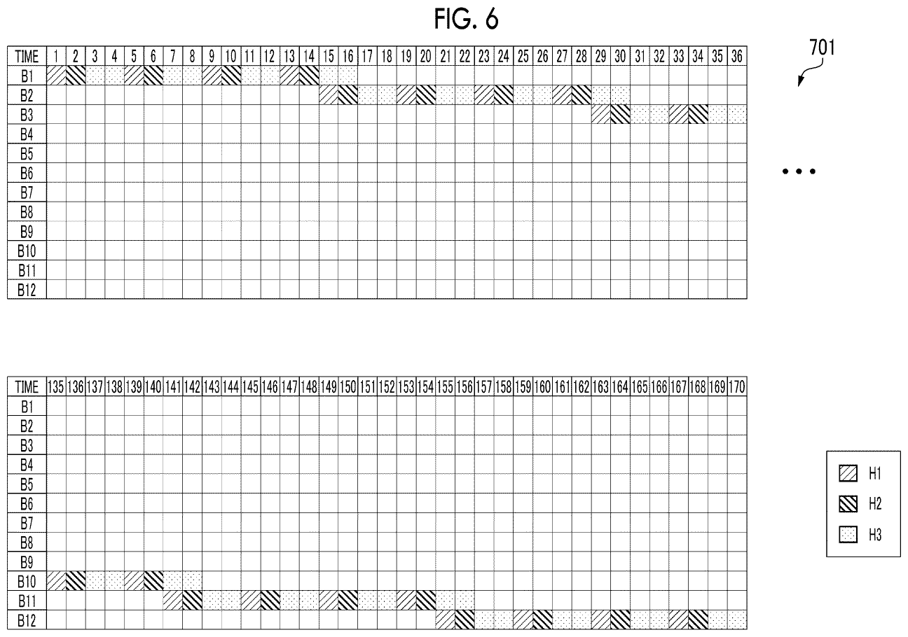

FIG. 6 is a diagram illustrating an operation pattern 701 according to a comparative example.

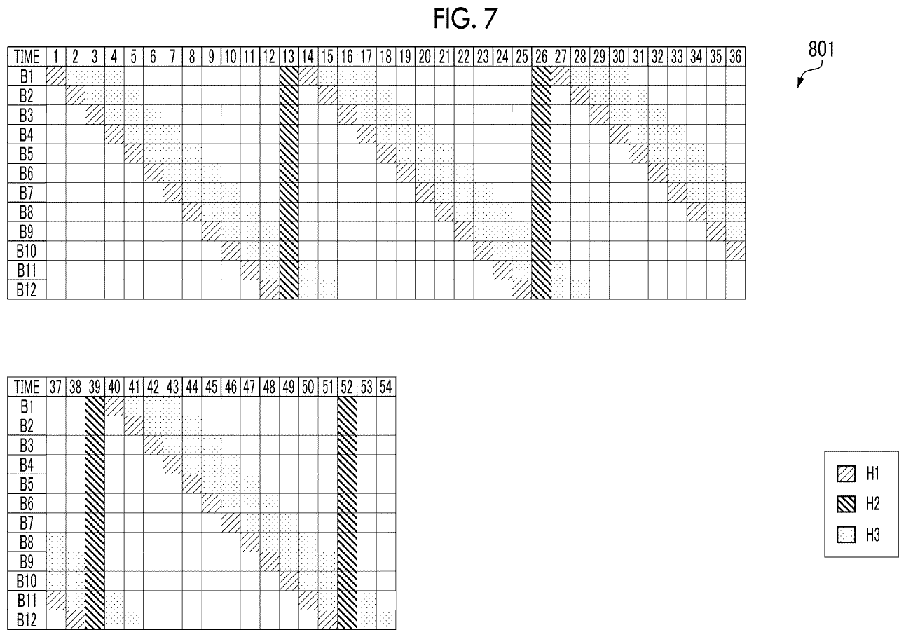

FIG. 7 is a diagram illustrating a first operation pattern 801 of the distance measurement apparatus 1 to which the present exemplary embodiment is applied.

In addition, in FIG. 6 and FIG. 7, the operation patterns 701 and 801 are described separately in two stages (front-stage and back-stage). Further, in FIG. 6, a part in the middle of the operation pattern 701, which is a part corresponding to between the front-stage and the back-stage, is omitted.

In FIG. 6 and FIG. 7, the item “time” in a first row indicates passage of time after a distance measurement apparatus starts an operation related to distance measurement, and indicates that a time passes in a right direction in FIG. 6 (proceeds to the right column). The number illustrated in each column indicates an elapsed time using a number u in unit times. As the unit time, a time corresponding to a light emitting period of each light emitting section 41 is used, which is 500 μs in this example.

Further, in FIGS. 6 and 7, the items “B1” to “B12” in a second row to a thirteenth row indicate which irradiation section 61 is the operation related to the distance measurement by using the reference numeral of the irradiation section Bi (i=1 to 12) (see FIG. 2 and FIG. 4). That is, a cell in which the column of the time u and the row of the irradiation section Bi intersect with each other indicates an operation related to distance measurement of the irradiation section Bi at a time point at which a unit time×u elapses from a start of the operation related to the distance measurement by the distance measurement apparatus.

In FIG. 6 and FIG. 7, a shaded cell H1 (see legend on the right side in FIG. 6 and FIG. 7) indicates that the corresponding light emitting section Ai performs a light emitting operation and the corresponding light receiving section Ci performs a light receiving operation. That is, the shaded cell H1 corresponds to a light emitting period of the corresponding light emitting section Ai. Further, a shaded cell H2 (see legend) indicates that the control unit 8 performs a read operation on the corresponding light receiving section Ci. In the distance measurement apparatus 1 to which the present exemplary embodiment is applied, the description will be made assuming that the control unit 8 requires one time of unit time, 500 μs, for the read operation on the light receiving section 51.

Here, in a case where a plurality of light emitting periods are provided for the light emitting section 41, a light non-emitting period during which the light emitting section 41 does not emit light is provided between the light emitting period and the next light emitting period. In a case where the light non-emitting period is too short, a temperature of the light emitting section 41 becomes too high due to heat generated by the light emission of the VCSEL, which may have an effect of a decrease in light output of the VCSEL, a decrease in life, or the like. Therefore, the light non-emitting period of the light emitting section 41 is provided to include a predetermined cooling period for reducing the influence of the heat generation associated with the light emission. Here, a case where the cooling period is 1500 μs (=unit time 500 μs×3 times) will be described as an example. A length of the cooling period is not limited since the length is determined according to a length of the light emitting period of the VCSEL, a heat radiation efficiency of the light emitting section 41, and the like.

In FIG. 6 and FIG. 7, a shaded cell H3 (see legend) indicates a light non-emitting period of the corresponding light emitting section Ai, which is a period secured as the cooling period. In addition, since it is possible to provide the read operation period by the control unit 8 and the cooling period in parallel, in that case, the shaded cell H2 is preferentially executed.

First, the operation pattern 701 of the comparative example illustrated in FIG. 6 will be described in detail.

In the operation pattern 701 of the comparative example, after an operation related to distance measurement of a certain irradiation section Bi is completed, an operation related to distance measurement of the next irradiation section Bj (j=i+1) is started. Here, the completion of the operation related to the distance measurement of the irradiation section Bi means that the scheduled number of four light emitting operations and light receiving operations and a read operation corresponding to each light receiving operation are completed and data necessary for the distance measurement of the irradiation section Bi is prepared.

More specifically, in the time u=1 of the operation pattern 701 of the comparative example, a light emitting operation in the light emitting section A1 corresponding to the irradiation section B1 and a light receiving operation at the first phase difference φ=0 degrees in the corresponding light receiving section CI are performed. Next, in the time u=2, the control unit 8 performs a read operation on the light receiving section C1, and ⅓ (for one time of unit time) of a cooling period of the light emitting section A1 elapses. Further, in the time u=3 and 4, the remaining ⅔ (for two times of unit time) of the cooling period of the light emitting section A1 elapses. Since a predetermined cooling period (for three times of unit time) elapses in the time u=2 to 4, in the time u=5, the light emitting operation in the light emitting section A1 and the light receiving operation at the second phase difference φ=0 degrees in the light receiving section C1 are performed. In the same manner as in the time u=2 to 4, in the time u=6 to 8, the read operation is performed by the control unit 8 and the cooling period of the light emitting section A1 elapses. In the same manner, in the time u=9 to 12, the light emitting operation in the light emitting section A1, the light receiving operation at the phase difference φ=180 degrees in the light receiving section C1, and the read operation by the control unit 8 are performed, and the cooling period of the light emitting section A1 is elapsed. In the time u=13, the light emitting operation in the light emitting section A1 and the light receiving operation at the second phase difference φ=180 degrees in the light receiving section C1 are performed, and in the time u=14, the read operation by the control unit 8 is performed, and then the operations related to distance measurement of the irradiation section B1 are completed. Subsequent operations related to distance measurement in the irradiation sections B2 to B12 are also performed in the same manner as the operations related to the distance measurement in the irradiation section B1. In a case where the control unit 8 performs the fourth read operation on the light receiving section C12 corresponding to the last irradiation section B12 in the time u=168, the distance measurement of all the irradiation sections 61 (B1 to B12) is completed.

In this manner, in the operation pattern 701 of the comparative example, after the operation related to the distance measurement of the irradiation section Bi is completed, the operation related to the distance measurement of the next irradiation section Bj (j=i+1) is repeatedly started. By completing the operation related to the distance measurement of the last irradiation section B12, the distance measurement of all the irradiation sections 61 is completed, and the data necessary for creating the distance image 100 by the control unit 8 is prepared. As illustrated in FIG. 6, in the operation pattern 701 of the comparative example, a time until the distance measurement of all the irradiation sections 61 is completed is the unit time u×168 (=84.0 ms).

Further, in the operation pattern 701 of the comparative example, after four light emitting periods in the light emitting section Ai, a light emitting period of another light emitting section Aj (j=i+1) is provided. As illustrated in FIG. 6, in the operation pattern 701 of the comparative example, a time until the scheduled number of four light emitting periods in all the light emitting sections 41 are completed is the unit time u×167 (=83.5 ms).

Next, the first operation pattern 801 of the distance measurement apparatus 1 to which the present exemplary embodiment illustrated in FIG. 7 is applied will be described in detail.

In the first operation pattern 801, at a time when an operation related to distance measurement of the irradiation section Bi is not completed, an operation related to distance measurement of the next irradiation section Bj (j=i+1) is started. More specifically, in a light non-emitting period of the light emitting section Ai between a light emitting period and the next light emitting period of the light emitting section Ai corresponding to a certain irradiation section Bi, a light emitting period of the next light emitting section Aj (j=i+1) is provided. In this example, the light emitting section Ai is an example of a first light emitting section, and the light emitting section Aj is an example of a second light emitting section.

Details will be described with reference to FIG. 7. In the time u=1 of the first operation pattern 801, a light emitting operation in the light emitting section A1 corresponding to the irradiation section B1 and a light receiving operation at the phase difference φ=0 degrees in the corresponding light receiving section C1 are performed. Next, in the time u=2, ⅓ (one time of unit time) of a cooling period of the light emitting section A1 elapses, and the light emitting operation in the light emitting section A2 corresponding to the irradiation section B2 and the light receiving operation at the phase difference φ=0 degrees in the corresponding the light receiving section C2 are performed. Further, in the time u=3, ⅓ of the cooling period of the light emitting section A1 and the light emitting section A2 elapses, and the light emitting operation in the light emitting section A3 corresponding to the irradiation section B3 and the light receiving operation at the phase difference φ=0 degrees in the corresponding light receiving section C3 are performed. This operations are repeated, and in the time u=12, in a case where the light emitting operation in the light emitting section A12 corresponding to the last irradiation section B12 and the light receiving operation at the phase difference φ=0 degrees in the corresponding light receiving section C12 are performed, in the time u=13, ⅓ of the cooling period of the light emitting sections A10, A11, and A12 with which the cooling period is not completed elapses, and the control unit 8 performs read operations for all the light receiving sections 51 (C1 to C12). Accordingly, the control unit 8 acquires a result of the light reception at the first phase difference φ=0 degrees for all the irradiation sections 61. In and after the time u=14, in the same manner, a result of light reception at the second phase difference φ=0 degrees, a result of light reception at the first phase difference φ=180 degrees, and a result of light reception at the second phase difference φ=180 degrees are acquired. In the time u=52, the control unit 8 performs the fourth read operations on the light receiving sections C1 to C12, so that the distance measurement of all the irradiation sections 61 (B1 to B12) is completed.

In the example of FIG. 7, the light emitting operations of the light emitting sections A1 to A12 are performed in numerical order, and the order of performing the light emitting operations is not limited. In the same manner, the order can be changed in the other operation patterns.

As described above, in the first operation pattern 801, after the light emitting operation of the light emitting section Ai and the light receiving operation of the light receiving section Ci, the light emitting operation of the next light emitting section Aj and the light receiving operation of the next light receiving section Cj are performed, and after the light receiving operation is completed once for all the irradiation sections 61, the read operations for all the light receiving sections 51 are performed. This is repeated four times, and by completing the read operation of the result of the fourth light reception, the distance measurement of all the irradiation sections 61 is completed, and data necessary for creating the distance image 100 (see FIG. 5C) by the control unit 8 is prepared. As illustrated in FIG. 7, in the first operation pattern 801, a time until the distance measurement of all the irradiation sections 61 is completed is the unit time u×52 (=26.0 ms).

Further, in the first operation pattern 801, after one light emitting period in the light emitting section Ai, a light emitting period of another light emitting section Aj (j=i+1) is provided. As illustrated in FIG. 7, in the first operation pattern 801, a time until the scheduled number of four light emitting periods in all the light emitting sections 41 are completed is the unit time u×51 (=25.5 ms).

In this manner, in the first operation pattern, the time (25.5 ms) until the scheduled number of light emitting periods in all the light emitting sections 41 are completed is shorter than the time (83.5 ms) in the operation pattern 701 of the comparative example.

Further, in the first operation pattern, the time (26.0 ms) until the distance measurement of all the irradiation sections 61 is completed is shorter than the time (84.0 ms) in the operation pattern 701 of the comparative example. As a result, in the distance measurement apparatus 1 that operates according to the first operation pattern 801, the time required for the control unit 8 to create one distance image 100 is shortened, as compared with the distance measurement apparatus that operates according to the operation pattern 701 of the comparative example.

Meanwhile, in some cases, the distance measurement apparatus 1 continuously creates and arranges in time-series the distance images 100 illustrated in FIG. 5C to create a moving image (referred to as a “distance moving image”) illustrating a distance measurement result corresponding to the passage of time. By using such a distance moving image, for example, it is possible to track a change in distance (position) of the target object S which is a moving object with the passage of time, calculate a movement speed, monitor a movement pattern, and the like.

The distance moving image is created with one distance image 100 as one frame, and has a frame rate corresponding to the number of distance images 100 created per unit time. As described above, in the distance measurement apparatus that operates according to the operation pattern 701 of the comparative example, the time required to complete the distance measurement of all the irradiation sections 61 is 84.0 ms, so that a frame rate of a distance moving image is 12 frames per second (fps) at a maximum. On the other hand, in the distance measurement apparatus 1 that operates according to the first operation pattern 801, the time required to complete the distance measurement of all the irradiation sections 61 is 26.0 ms, so that the frame rate of the distance moving image is improved up to 38 fps at a maximum. Thus, the distance moving image can be used for tracking the target object S having a higher movement speed.

Next, an example of another operation pattern of the distance measurement apparatus 1 to which the present exemplary embodiment is applied will be described.

In addition, in FIG. 8 to FIG. 14 to be described below, contents indicated by each item in a first row to a thirteenth row and the shaded cells H1 to H3 have the same manner as the corresponding notations in FIG. 7. Further, in each of FIG. 8 to FIG. 14, an operation pattern may be described separately in two stages (front-stage and back-stage). Further, in the same manner as the first operation pattern 801 described with reference to FIG. 7, in any operation pattern, a case where a light emitting period of each light emitting section 41 is 500 μs and a cooling period is 1500 μs will be described as an example.

FIG. 8 is a diagram illustrating a second operation pattern 802 of the distance measurement apparatus 1 to which the present exemplary embodiment is applied.

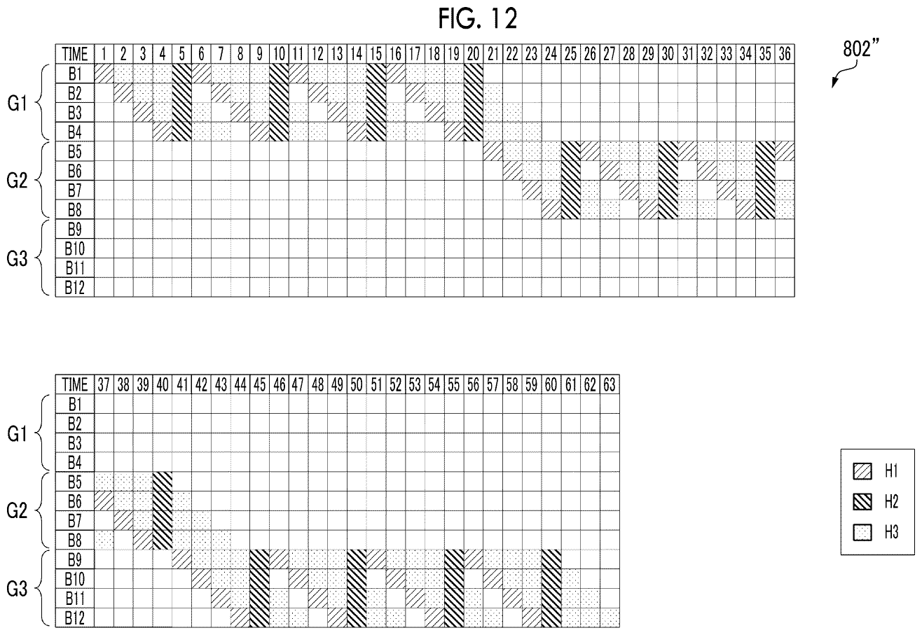

In the second operation pattern 802, the irradiation sections 61, the corresponding light emitting sections 41, and the corresponding light receiving sections 51 are divided into a plurality of groups, and an operation of the distance measurement apparatus 1 is defined based on this grouping. As illustrated in FIG. 8, the irradiation sections B1 to B3 belong to a group G1, the irradiation sections B4 to B6 belong to a group G2, the irradiation sections B7 to B9 belong to a group G3, and the irradiation sections B10 to B12 belong to a group G4. In addition, each light emitting section Ai and each light receiving section Ci belong to the same group as the corresponding irradiation section Bi. In addition, although FIG. 8 illustrates a case where the irradiation sections 61, the corresponding light emitting sections 41, and the corresponding light receiving sections 51 belong to each group three by three, the case is not limited thereto. The grouping may be performed according to the number of light emitting sections 41 included in the light emitting unit 4 (see FIG. 2) or a priority performance (to be described below with reference to FIG. 12). Hereinafter, these groups G1 to G4 may be referred to as a group G without distinguishing the groups G1 to G4.

In the second operation pattern 802 illustrated in FIG. 8, after an operation related to distance measurement of a group Gi is completed, an operation related to distance measurement of a group Gj (j=i+1) is started. From the viewpoint of a light emitting operation, in a light non-emitting period of the light emitting section Ai belonging to the group Gi, a light emitting period of the light emitting section Aj (j≠i) belonging to the same group Gi is provided. After the scheduled number of four light emitting periods in the light emitting sections Ai and Aj belonging to the group Gi, a light emitting period of a light emitting section Ak (k≠i, j) belonging to the group Gj is provided. In this example, the light emitting section Ai is an example of a first light emitting section, the light emitting section Aj is an example of a second light emitting section, the group Gi is an example of one light emitting section group, and the group Gj is an example of another light emitting section group.

As illustrated in FIG. 8, in the second operation pattern 802, in the time u=1, the light emitting section A1 corresponding to the irradiation section B1 performs a light emitting operation, and the corresponding light receiving section CI performs a light receiving operation at the first phase difference φ=0 degrees. Further, in the time u=2, the light emitting section A2 corresponding to the irradiation section B2 performs the light emitting operation, and the corresponding light receiving section C2 performs a light receiving operation. Further, in the time u=3, the light emitting section A3 corresponding to the irradiation section B3 performs the light emitting operation, and the corresponding light receiving section C3 performs the light receiving operation. In the time u=4, the control unit 8 performs a read operation for each of the light receiving sections C1 to C3. Accordingly, the distance measurement apparatus 1 (control unit 8) acquires a result of the light reception in the irradiation sections B1 to B3 belonging to the group G1 at the first phase difference φ=0 degrees. That is, in the second operation pattern 802, after the light emitting period is completed once for all the light emitting sections A1 to A3 belonging to the group G1 once, the control unit 8 acquires the result of the light reception by the light receiving sections C1 to C3 between a start of the light emitting period of the first light emitting section A1 and an end of the light emitting period of the last light emitting section A3. A cooling period of the light emitting section A1 is secured in the time u=2 to 4, the cooling period of the light emitting section A2 is secured in the time u=3 to 5, and the cooling period of the light emitting section A1 is secured in the time u=4 to 6. In the same manner, in the time u=5 to 8, a result of light reception at the second phase difference φ=0 degrees is acquired, in the time u=9 to 12, a result of light reception at the first phase difference φ=180 degrees is obtained, and in the time u=13 to 16, a result of light reception at the second phase difference φ=180 degrees is acquired. In this manner, in the time u=1 to 16, four light emitting operations in the light emitting sections A1 to A3 corresponding to the irradiation sections B1 to B3 of the group G1, four light receiving operations in the corresponding light receiving sections C1 to C3, and four read operations on the light receiving sections C1 to C3 by the control unit 8 are performed. In other words, in the time u=16, the scheduled number of four light emitting operations, light receiving operations, and read operations for all the irradiation sections B1 to B3 belonging to the group G1 are completed, and the operation related to the distance measurement of the group G1 is completed.

In a case where the operation related to the distance measurement of the group G1 is completed, in the time u=17, the light emitting section A4 corresponding to the irradiation section B4 performs a light emitting operation and the corresponding light receiving section C4 performs a light receiving operation at the first phase difference φ=0 degrees, so that an operation related to distance measurement of the group G2 is started. Further, in the same manner as the group G1, the light emitting sections A4 to A6 belonging to the group G2 perform the scheduled number of four light emitting operations, the light receiving sections C4 to C6 perform the scheduled number of four light receiving operations, and the control unit 8 performs four read operations, so the operation related to the distance measurement of the group G2 is completed in the time u=32. In the same manner, an operation related to distance measurement of the group G3 is performed in the time u=33 to 48, and an operation related to distance measurement of the group G4 is performed in the time u=49 to 64. Thus, in the second operation pattern 802, the distance measurement of all the irradiation sections 61 (B1 to B12) is completed.

In this manner, in the second operation pattern 802, by performing the fourth read operation on the last group G4, the distance measurement of all the irradiation sections 61 is completed, and data necessary for creating the distance image 100 (see FIG. 5C) by the control unit 8 is prepared. As illustrated in FIG. 8, in the second operation pattern 802, a time until the distance measurement of all the irradiation sections 61 is completed is the unit time u×64 (=32.0 ms). In addition, a time until the scheduled number of four light emitting periods in all the light emitting sections 41 are completed is the unit time u×63 (=31.5 ms). That is, in a case where the second operation pattern 802 is applied as well, the time (31.5 ms) until the scheduled number of light emitting periods in all the light emitting sections 41 are completed is shorter than the time (83.5 ms) in the operation pattern 701 of the comparative example. In addition, the time (32.0 ms) until the distance measurement of all the irradiation sections 61 is completed is also shorter than the time (84.0 ms) in the operation pattern 701 of the comparative example. As a result, in the distance measurement apparatus 1 that operates according to the second operation pattern 802 as well, the time required for the control unit 8 to create one distance image 100 is shortened, as compared with the distance measurement apparatus that operates according to the operation pattern 701 of the comparative example. In addition, in the distance measurement apparatus 1 that operates according to the second operation pattern 802, a frame rate of a distance moving image is improved up to 31 fps at a maximum.

Here, in a case where the target object S (see FIG. 5A) is a moving object and an interval (distance measurement interval) between the light emitting operation and the light receiving operation and the next light emitting operation and the next light receiving operation for a certain irradiation section 61 of the distance measurement apparatus 1 is large, an effect of motion artifacts may be large. More specifically, for example, in a case where an interval between the first light emitting operation of the light emitting section 41 corresponding to a certain irradiation section 61 and the first light receiving operation of the light receiving section 51, and the second light emitting operation of the same light emitting section 41 and the second light receiving operation of the light receiving section 51 is large, the movement of the target object S becomes large during this interval, and a large difference occurs between the result of the first light reception and the result of the second light reception. This difference in result of the light reception affects a result of distance measurement as a motion artifact. For example, a large error occurs in the distance to the target object S, and an image S′ may be illustrated in a shape different from a shape of the actual object S in the distance image 100 (see FIG. 5C), which may lead to a decrease in accuracy of the distance measurement.

As described with reference to FIG. 7, in the first operation pattern 801, for example, for the irradiation section B1, the first light emitting operation and light receiving operation are performed in the time u=1, and the second light emitting operation and light receiving operation are performed at the time u=14. That is, in the distance measurement apparatus 1 that operates according to the first operation pattern 801, a distance measurement interval is 12 times of unit time (6.0 ms).

On the other hand, in the second operation pattern 802, for example, the first light emitting operation and light receiving operation for the irradiation section B1 are performed in the time u=1, and the second light emitting operation and light receiving operation are performed in the time u=5. That is, in the distance measurement apparatus 1 that operates according to the second operation pattern 802, a distance measurement interval is three times of unit time (1.5 ms), and an influence of motion artifacts can be reduced as compared with the case where the distance measurement apparatus 1 operates according to the first operation pattern 801.

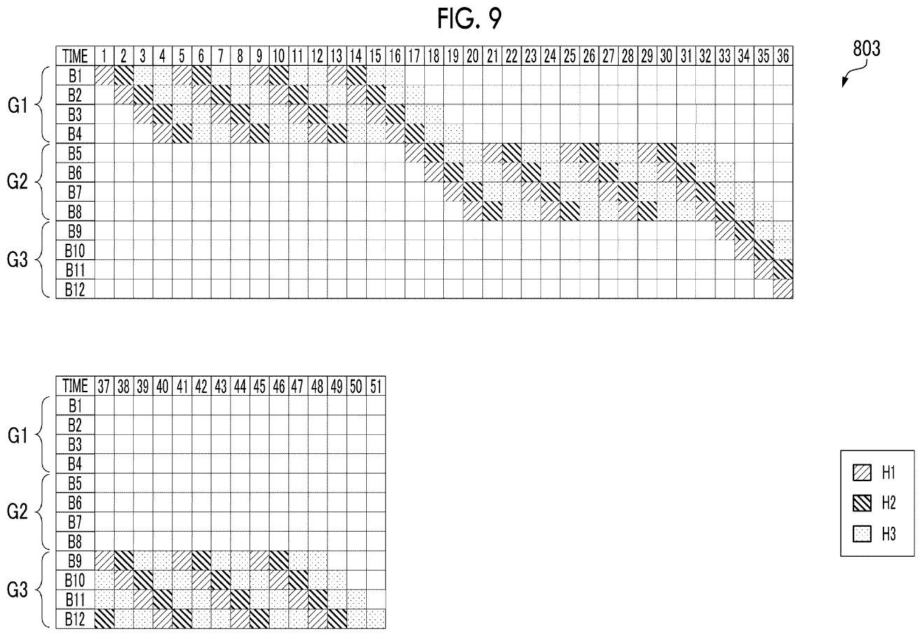

FIG. 9 is a diagram illustrating a third operation pattern 803 of the distance measurement apparatus 1 to which the present exemplary embodiment is applied.

In the first operation pattern 801 and the second operation pattern 802 described with reference to FIGS. 7 and 8, a case where that operation pattern is defined such that the read operation on the light receiving section Ci by the control unit 8, and the light emitting operation of the light emitting section Aj (j≠i) and the light receiving operation of the light receiving section Ci are not performed in parallel is described as an example. On the other hand, in the third operation pattern 803 illustrated in FIG. 9, a read operation on the light receiving section Ci by the control unit 8, and a light emitting operation of the light emitting section Aj (j≠i) and a light receiving operation of the light receiving section Cj are allowed to be performed in parallel. More specifically, in the third operation pattern 803, in a period in which the control unit 8 performs the read operation on the light receiving section Ci and acquires a result of light reception in the light receiving section Ci, the light emitting section Aj (j≠i) performs a light emitting operation to provide a light emitting period. In this example, the light emitting section Ai is an example of a first light emitting section, and the light emitting section Aj is an example of a second light emitting section.

In the third operation pattern 803, the irradiation sections B1 to B4 belong to the group G1, the irradiation sections B5 to B8 belong to the group G2, and the irradiation sections B9 to B12 belong to the group G3, and an operation of the distance measurement apparatus 1 is defined based on this grouping. In addition, the light emitting sections A1 to A12 and the light receiving sections C1 to C12 respectively belong to the same group as the corresponding irradiation sections 61. Hereinafter, these groups G1 to G3 may be referred to as a group G without distinguishing the groups G1 to G3.

As illustrated in FIG. 8, in the third operation pattern 803, in the time u=1, the light emitting section A1 corresponding to the irradiation section B1 performs a light emitting operation, and the corresponding light receiving section C1 performs a light receiving operation at the first phase difference φ=0 degrees. Further, in the time u=2, the light emitting section A2 corresponding to the irradiation section B2 performs the light emitting operation and the corresponding light receiving section C2 performs a light receiving operation, in parallel with a read operation on the light receiving section CI by the control unit 8. Further, in the time u=3, the light emitting section A3 corresponding to the irradiation section B3 performs the light emitting operation and the corresponding light receiving section C3 performs the light receiving operation, in parallel with the read operation on the light receiving section C2 by the control unit 8. Further, in the time u=4, the light emitting section A4 corresponding to the irradiation section B4 performs the light emitting operation and the corresponding light receiving section C4 performs the light receiving operation, in parallel with the read operation on the light receiving section C3 by the control unit 8. In the time u=5, the light emitting section A1 performs the light emitting operation and the light receiving section C1 performs the second light receiving operation at the phase difference φ=0 degrees, in parallel with the read operation on the light receiving section C4 by the control unit 8. Accordingly, the distance measurement apparatus 1 (control unit 8) acquires a result of the first light reception at the phase difference φ=0 degrees in the irradiation sections BI to B4 and acquires a result of the second light reception at the phase difference φ=0 degrees, and starts the operation related to distance measurement. This is repeated, and in the time u=1 to 17, four light emitting operations in the light emitting sections A1 to A4 corresponding to the irradiation sections B1 to B4 of the group G1, four light receiving operations in the corresponding light receiving sections C1 to C4, and four read operations on the light receiving sections C1 to C4 by the control unit 8 are performed. In other words, in the time u=17, the scheduled number of four light emitting operations, light receiving operations, and read operations for all the irradiation sections B1 to B4 belonging to the group G1 are completed, and the operation related to the distance measurement of the group G1 is completed.

Further, in the time u=17, in parallel with the fourth read operation on the light receiving section C4 by the control unit 8, the light emitting section A5 corresponding to the irradiation section B5 performs the light emitting operation and the corresponding light receiving section C5 performs the first light receiving operation at the phase difference φ=0 degrees, so that an operation related to distance measurement of the group G2 is started. Further, in the same manner as the group G1, the light emitting sections A5 to A8 belonging to the group G2 perform the scheduled number of four light emitting operations, the light receiving sections C5 to C8 perform the four light receiving operations, and the control unit 8 performs the four read operations on the light receiving sections C5 to C8, and in the time u=33, the operation related to the distance measurement of the group G2 is completed. In the same manner, an operation related to distance measurement of the group G3 is performed in the time u=34 to 49. Thus, in the third operation pattern 803, the distance measurement of all the irradiation sections 61 (B1 to B12) is completed.

As illustrated in FIG. 9, in the third operation pattern 803, a time until the distance measurement of all the irradiation sections 61 is completed is the unit time u×49 (=24.5 ms), and is shorter than the time (84.0 ms) in the operation pattern 701 of the comparative example. In addition, a time until the scheduled number of four light emitting periods in all the light emitting sections 41 are completed is the unit time u×48 (=24.0 ms), and is shorter than the time (83.5 ms) in the operation pattern 701 of the comparative example. In addition, in the distance measurement apparatus 1 that operates according to the third operation pattern 803, a frame rate of a distance moving image is improved up to 40 fps at a maximum. Further, a distance measurement interval in the third operation pattern 803 is three times of unit time (1.5 ms), and an influence of motion artifacts can be reduced as compared with the case of the operation according to the first operation pattern 801.

Here, adjacency between the light emitting sections 41 will be described with reference to FIG. 2. As described above, in the light emitting unit 4 according to the present exemplary embodiment, the 12 light emitting sections A1 to A12 are arranged in two directions of the x-direction (right-left direction of the page plane of FIG. 2) and the y-direction (up-down direction of the page plane of FIG. 2) orthogonal to the x-direction. Being adjacent to a certain light emitting section Ai means that being arranged in any one direction of the x-direction or the y-direction with respect to the light emitting section Ai without being interposed with another light emitting section 41. Thus, the light emitting section 41 that is arranged with the light emitting sections Ai interposed with another light emitting section 41 and the light emitting section 41 that is arranged in an oblique direction of the page plane of FIG. 2, that is, in the x-direction and the y-direction with respect to the light emitting sections Ai are not adjacent to the light emitting section Ai. For example, in the light emitting unit 4 illustrated in FIG. 2, only the light emitting sections A2 arranged in the +y direction with respect to the light emitting section A6, the light emitting sections A5 arranged in the +x direction, the light emitting sections A7 arranged in the −x direction, and the light emitting sections A10 arranged in the −y direction are adjacent to the light emitting section A6, and the other light emitting sections 41 are light emitting sections 41 that are not adjacent to the light emitting sections A6.

In the second operation pattern 802 and the third operation pattern 803 described in FIGS. 8 and 9, the grouping is performed such that the light emitting sections 41 belonging to the same group G are adjacent to each other. A method of grouping is not limited, and light emitting sections 41 that are not adjacent to each other may belong to the same group G, for example, the light emitting sections A1, A7, and A12. Meanwhile, in a case where the group G is configured with the light emitting sections 41 adjacent to each other as in the examples of FIGS. 8 and 9, the corresponding irradiation sections 61 are also close to each other. As a result, the scheduled number of light emitting operations and light receiving operations on the irradiation sections 61 that are close to each other are performed in a short time, which contributes to improving of accuracy of the distance measurement in the distance measurement apparatus 1.

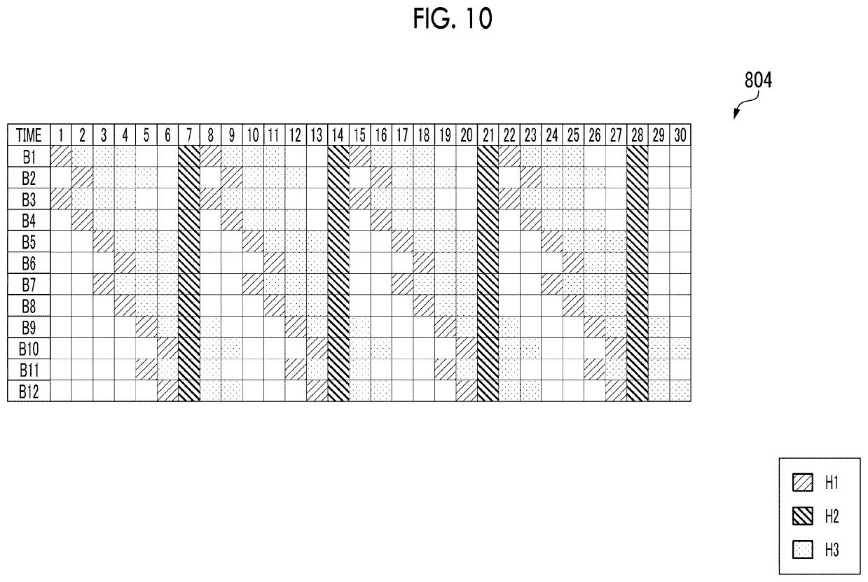

FIG. 10 is a diagram illustrating a fourth operation pattern 804 of the distance measurement apparatus 1 to which the present exemplary embodiment is applied.

In the first operation pattern 801, the second operation pattern 802, and the third operation pattern 803 described with reference to FIGS. 7 to 9, a case where the operation pattern is defined such that a light emitting period in a certain light emitting section Ai and a light emitting period in another light emitting section Aj (j≠i) do not overlap with each other is described as an example. On the other hand, in the fourth operation pattern 804 illustrated in FIG. 10, a light emitting operation is allowed to be performed such that a light emitting period in a certain light emitting section Ai overlaps with a light emitting period in the light emitting section Ak (k≠i) that is not adjacent to the light emitting section Ai. In this example, the light emitting section Ai is an example of a first light emitting section, and the light emitting section Ak is an example of a third light emitting section.

In the fourth operation pattern 804, in the time u=1, the light emitting section A1 corresponding to the irradiation section B1 performs a light emitting operation, and the corresponding light receiving section C1 performs a first light receiving operation at the phase difference φ=0 degrees. In the same manner, in the time u=1, in parallel, the light emitting section A3 corresponding to the irradiation section B3 performs the light emitting operation, and the corresponding light receiving section C3 performs the first light receiving operation at the phase difference φ=0 degrees. Further, in the time u=2, the light emitting section A2 corresponding to the irradiation section B2 performs the light emitting operation, and the corresponding light receiving section C2 performs a light receiving operation. In the same manner, in the time u=2, in parallel, the light emitting section A4 corresponding to the irradiation section B4 performs the light emitting operation, and the corresponding light receiving section C4 performs the light receiving operation. In the same manner, regarding a combination of the irradiation sections B5 and B7, a combination of the irradiation sections B6 and B8, a combination of the irradiation sections B9 and B11, and a combination of the irradiation sections B10 and B12, the light emitting operation of the corresponding light emitting section 41 and the light receiving operation of the corresponding light receiving section 51 are performed in parallel. Thus, in the fourth operation pattern 804, regarding a combination of the light emitting sections A1 and A3 that are not adjacent to each other, a combination of the light emitting sections A2 and A4, a combination of the light emitting sections A5 and A7, a combination of the light emitting sections A6 and A8, a combination of the light emitting sections A9 and A11, and a combination of the light emitting sections A10 and A12, the light emitting operations are performed at the same time u, and the light emitting periods overlap with each other. In the time u=7, the control unit 8 performs a read operation for each of the light receiving sections C1 to C12, thereby acquiring a result of the first light reception at the phase difference φ=0 degrees for all the irradiation sections 61. In the same manner, in the time u=8 to 14, a result of the second light reception at the phase difference φ=0 degrees is acquired, in the time u=15 to 21, a result of the first light reception at the phase difference φ=180 degrees is acquired, and in the time u=22 to 28, a result of the second light reception at the phase difference φ=180 degrees is acquired. Thus, in the fourth operation pattern 804, the distance measurement of all the irradiation sections 61 (B1 to B12) is completed.

As illustrated in FIG. 10, in the fourth operation pattern 804, a time until the distance measurement of all the irradiation sections 61 is completed is the unit time u×28 (=14.0 ms), and is shorter than the time (84.0 ms) in the operation pattern 701 of the comparative example. In addition, a time until the scheduled number of four light emitting periods in all the light emitting sections 41 are completed is the unit time u×27 (=13.5 ms), and is shorter than the time (83.5 ms) in the operation pattern 701 of the comparative example. In addition, in the distance measurement apparatus 1 that operates according to the fourth operation pattern 804, a frame rate of a distance moving image is improved up to 71 fps at a maximum. Further, a distance measurement interval in the fourth operation pattern 804 is six times of unit time (3.0 ms), and an influence of motion artifacts can be reduced as compared with the case of the operation according to the first operation pattern 801.

Here, unlike the fourth operation pattern 804 described above, the operation pattern of the distance measurement apparatus 1 can be set such that the light emitting period of the light emitting section Ai and the light emitting period of the adjacent light emitting section Aj (j≠i, k) overlap with each other. In this case as well, in the same manner as the fourth operation pattern 804, a time until the distance measurement of all the irradiation sections 61 is completed and a time until the scheduled number of light emitting periods in all the light emitting sections 41 are completed are shortened. Meanwhile, in a case where the light emitting periods of the adjacent light emitting sections Ai and Aj overlap with each other, the periods during which the corresponding light receiving sections Ci and Cj perform the light receiving operations overlap with each other. As a result, for example, light emitted by the light emitting section Ai and reflected in the corresponding irradiation section Bi is incident not only onto the corresponding light receiving section Ci but also onto the adjacent light receiving section Cj, which may lead to a decrease in accuracy of the distance measurement in the light receiving section Cj. Therefore, for example, as in the fourth operation pattern 804, the operation pattern of the distance measurement apparatus 1 may be set such that the light emitting period of the light emitting section Ai and the light emitting period of the non-adjacent light emitting section Ak are allowed to overlap with each other and the light emitting period of the light emitting section Ai and the adjacent light emitting section Aj are not allowed to overlap with each other.

A combination of light emitting sections 41 of which light emitting periods overlap with each other is not limited to the one illustrated in FIG. 10. For example, the light emitting periods may overlap with each other in a combination different from the above, such as a combination of the light emitting sections A1 and A4 and a combination of the light emitting sections A2 and A9.

Further, in the example of FIG. 10, for the combination of any two light emitting sections 41, the operation pattern is set such that the light emitting periods overlap with each other, and the number of light emitting sections 41 of which the light emitting periods overlap with each other is not limited. For example, the light emitting periods may overlap in a combination of three or more light emitting sections 41 that are not adjacent to each other.

Further, in the example of FIG. 10, the operation pattern is set such that the read operations of all the light receiving sections 51 (C1 to C12) are performed at the same time u, and the read operations may be performed on some or all of the light receiving sections 51 at different times u, in the same manner as the operation patterns 802 and 803 illustrated in FIGS. 8 and 9, for example.

### Others

### Cooling Period

In each of the first to fourth operation patterns 801, 802, 803, and 804 described above, a case where the cooling period is three times of unit time is described as an example. A length of the cooling period is not limited, and may be shorter or longer than three times of unit time. Further, the cooling period is not limited to an integral multiple of unit time. In any case, the operation pattern may be set such that during the light non-emitting period of the light emitting section Ai between the light emitting period and the next light emitting period of the light emitting section Ai corresponding to a certain irradiation section Bi, the light emitting period of the next light emitting section Aj (j=i+1) is provided. As an example, a modification example in which the cooling period is set to four times of unit time in the second operation pattern 802 will be described.

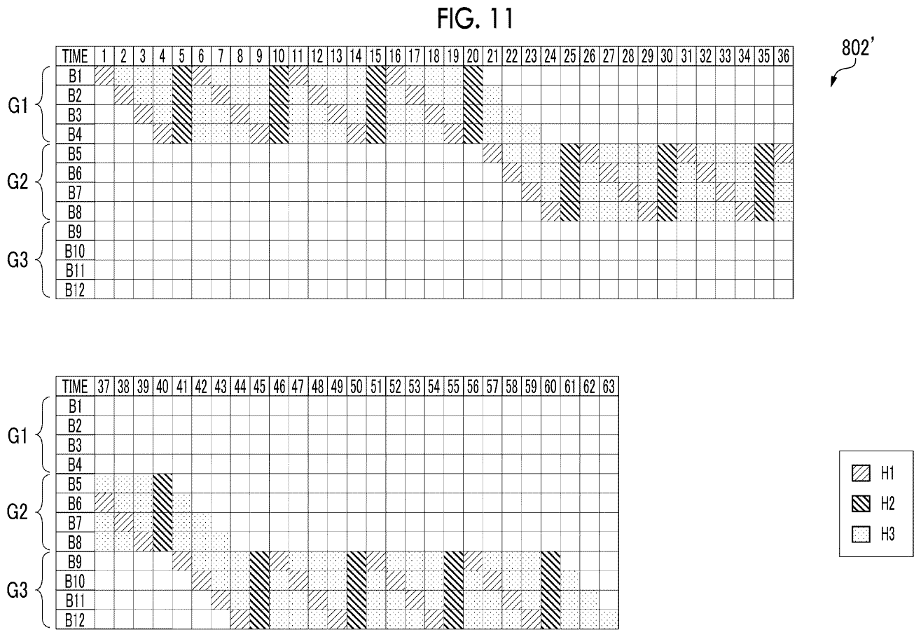

FIG. 11 is a diagram illustrating a modification example 802′ of the second operation pattern 802.

As illustrated in FIG. 11, in the modification example 802′, the irradiation sections B1 to B4 belong to the group G1, the irradiation sections B5 to B8 belong to the group G2, and the irradiation sections B9 to B12 belong to the group G3, and an operation of the distance measurement apparatus 1 is defined based on this grouping. In addition, the light emitting sections A1 to A12 and the light receiving sections C1 to C12 respectively belong to the same group as the corresponding irradiation sections 61.

In the modification example 802′, an operation of the distance measurement apparatus 1 in the time u=1 to 3 is the same as the operation of the second operation pattern 802. In the time u=4, the light emitting section A4 corresponding to the irradiation section B4 performs a light emitting operation, and the corresponding light receiving section C4 performs a light receiving operation. In the time u=5, the control unit 8 performs a read operation for each of the light receiving sections C1 to C4. Accordingly, the distance measurement apparatus 1 (control unit 8) acquires a result of the light reception in the irradiation sections B1 to B4 belonging to the group G1 at the first phase difference φ=0 degrees. A cooling period of the light emitting section A1 is secured in the time u=2 to 5, the cooling period of the light emitting section A2 is secured in the time u=3 to 6, the cooling period of the light emitting section A3 is secured in the time u=4 to 7, and the cooling period of the light emitting section A4 is secured in the time u=5 to 8. In the same manner, in the time u=6 to 10, a result of the second light reception at the phase difference φ=0 degrees is acquired, in the time u=11 to 15, a result of the first light reception at the phase difference φ=180 degrees is acquired, and in the time u=16 to 20, a result of the second light reception at the phase difference φ=180 degrees is acquired. In this manner, in the time u=1 to 20, four light emitting operations in the light emitting sections A1 to A4 corresponding to the irradiation sections B1 to B4 of the group G1, four light receiving operations in the corresponding light receiving sections C1 to C4, and four read operations on the light receiving sections C1 to C4 by the control unit 8 are performed. Further, after the light emitting operations of the light emitting sections A1 to A4, the cooling periods for four times of unit time including the read operation period are secured.

After that, an operation related to distance measurement is performed in the same manner on the other groups G2 and G3.

As illustrated in FIG. 11, in the modification example 802′, a time until the distance measurement of all the irradiation sections 61 is completed is the unit time u×60 (=30.0 ms), and is shorter than the time (84.0 ms) in the operation pattern 701 of the comparative example. In addition, a time until the scheduled number of four light emitting periods in all the light emitting sections 41 are completed is the unit time u×59 (=29.5 ms), and is shorter than the time (83.5 ms) in the operation pattern 701 of the comparative example. In addition, in the distance measurement apparatus 1 that operates according to the modification example 802′, a frame rate of a distance moving image is improved up to 33 fps at a maximum. Further, a distance measurement interval in the fourth operation pattern 804 is four times of unit time (2.0 ms).

In this manner, in a case where the operation pattern is modified according to the cooling period, it is also possible to shorten a time until the scheduled number of light emitting periods are completed. Although the modification example 802′ of the second operation pattern 802 is illustrated, the first, third, and fourth operation patterns 801, 803, and 804 can also be modified according to the cooling period.

Meanwhile, depending on a temperature of an environment in which the light emitting unit 4 is installed, transition of a temperature of the light emitting unit 4 after performing a light emitting operation may be different. For example, in a case where the light emitting unit 4 is installed in a low-temperature environment, the temperature of the light emitting unit 4 drops faster after the light emitting operation, as compared with a case where the light emitting unit 4 is installed in a high-temperature environment. Therefore, the cooling period of the light emitting unit 4 may be determined based on the temperature of the environment and the temperature of the light emitting unit 4. For example, the control unit 8 may acquire the temperature of the environment measured by a temperature sensor or the like and the temperature of the light emitting unit 4, and determine the cooling period according to the acquired temperature information. More specifically, for example, in a case where a difference between the temperature of the environment and the temperature of the light emitting unit 4 is large, the control unit 8 may determine the cooling period to be decreased, and in a case where the difference between the temperature of the environment and the temperature of the light emitting unit 4 is small, the control unit 8 may determine the cooling period to be increased. For example, the control unit 8 may select an operation pattern corresponding to the determined cooling period, and control the operation related to the distance measurement.

### Light Non-emitting Period

Further, in the first to fourth operation patterns 801, 802, 803, and 804 and the modification example 802′ described above, the case where the light non-emitting period coincides with the cooling period is described as an example. A length of the light non-emitting period is not limited and may be longer than the cooling period. As an example, a modification example in which a cooling period is set to three times of unit time and a light non-emitting period is set to four times of unit time in the second operation pattern 802 will be described.

FIG. 12 is a diagram illustrating a modification example 802″ of the second operation pattern 802.

As illustrated in FIG. 12, the modification example 802″ has the same manner as the modification example 802′ illustrated in FIG. 11, except that a cooling period in each light emitting section 41 is three times of unit time. Thus, in the modification example 802″, a time until distance measurement of all the irradiation sections 61 is completed (60 times of unit time=30.0 ms), a time until the scheduled number of four light emitting periods in all the light emitting sections 41 are completed (59 times of unit time=29.5 ms), a frame rate of a distance moving image (maximum 33 fps), and a distance measurement interval (4 times of unit time=2.0 ms) are equal to the modification example 802′.

In this manner, in a case where the light non-emitting period is different from the cooling period, it is also possible to shorten the time until the scheduled number of light emitting periods are completed.

Since the number of light emitting sections 41 belonging to each group G or the length of the light non-emitting period is not limited, the operation pattern also can be set such that the number of light emitting sections 41 belonging to each group G and the number of times of unit time defined as the light non-emitting period are different. Meanwhile, as in the second operation pattern 802, the third operation pattern 803, the modification example 802′, and the modification example 802″, in a case where the number of light emitting sections 41 belonging to each group G and the number of times of unit time defined as the light non-emitting period coincide with each other, a time until the scheduled number of light emitting periods in each group G becomes shorter than a case where these are different from each other.

Further, as compared with the second operation pattern 802 in which the light non-emitting period coincides with the cooling period, in the modification example 802″, the time until the distance measurement in all the irradiation sections 61 is completed, and the time until the scheduled number of four light emitting periods in all the light emitting sections 41 are completed are shortened, and a frame rate of a distance moving image is improved. On the other hand, a distance measurement interval is shorter than the second operation pattern 802. That is, in a case where the number of light emitting sections 41 belonging to each group G and the number of times of unit time defined as the light non-emitting period coincide with each other, the light non-emitting period is made longer than the cooling period and the number of light emitting sections 41 belonging to each group G is increased as in modification example 802″, so that it is possible to shorten the time until the distance measurement for all the irradiation sections 61 is completed and the time until the scheduled number of four light emitting periods in all the light emitting sections 41 are completed and the frame rate of the distance moving image is improved. On the contrary, as in the second operation pattern 802, by matching the light non-emitting period with the cooling period and reducing the number of light emitting sections 41 belonging to each group G, the distance measurement interval can be shortened. In this manner, the light non-emitting period may be determined according to performance prioritized in the distance measurement apparatus 1.

As with the cooling period, the light non-emitting period is not limited to an integral multiple of unit time. Therefore, it is also possible to match a light non-emitting period with a cooling time that is not an integral multiple of unit time and provide the light non-emitting period that is not an integral multiple of unit time. Meanwhile, in a case where a period of the light emitting operation or the read operation corresponds to the unit time as in the examples of FIGS. 7 to 12, the operation pattern is easily set by setting the light non-emitting period to an integral multiple of unit time. Thus, for example, even in a case where the cooling period is not an integral multiple of unit time, the light non-emitting period may be provided by an integral multiple of unit time. For example, in a case where the cooling period is 2.5 times of unit time, by setting the light non-emitting period to three times of unit time, the light non-emitting period may be an integral multiple of unit time while securing the cooling period.

### Unit Time

In the example described above, the case where the operation pattern is set such that the light emitting period in which the light emitting section 41 performs the light emitting operation and the period in which the control unit 8 performs the read operation on the light receiving section 51 are equal to each other and a time (500 μs) corresponding to the light emitting period and the read operation period is used as the unit time is described. The light emitting period and the read operation period may be different from each other, and a time corresponding to either the longer one or the shorter one among the light emitting period and the read operation period can be set as the unit time. In a case where the longer one is selected, the longer light non-emitting period is secured, as compared with a case where the shorter one is set as the unit time. On the contrary, in a case where the shorter one is selected, the time until the scheduled number of light emitting periods in all the light emitting sections 41 are completed is shorter as completed with a case where the longer one is set as the unit time.

In addition, unlike the example described above, the operation pattern may be set without being based on the unit time.

### Scheduled Number of Times

In the example described above, the operation pattern is described by using a case where each light emitting section 41 has the scheduled number of four light emitting periods. The scheduled number of times is not limited. For example, in the indirect ToF method, in some cases, distance measurement is performed based on results of light reception twice at each of four phase differences φ of 0 degrees, 90 degrees, 180 degrees, and 270 degrees with respect to light emission. Thus, in a case of performing distance measurement of, for example, a certain irradiation section Bi in the distance measurement apparatus 1, a light emitting operation in the corresponding light emitting section Ai, a light receiving operation at the phase difference φ in the corresponding light receiving section Ci, and a read operation for the light receiving section Ci by the control unit 8 are respectively repeated eight times. More specifically, the light emitting operation is performed eight times in each light emitting section 41, the light receiving operation is performed eight times in each light receiving section 51, and the read operation is performed eight times for each light receiving section 51.

As the scheduled number of times is increased, a time required for an operation related to distance measurement is increased. For example, in the operation pattern 701 (see FIG. 6) of the comparative example, in a case where the scheduled number of times is eight, the time required to complete the distance measurement of all the irradiation sections 61 is 240 times of unit time (120.0 ms). In addition, a time until the light emitting periods are completed in all the light emitting sections 41 is 239 times of unit time (119.5 ms). A frame rate of a distance moving image is 5 fps at a maximum.

Hereinafter, a fifth operation pattern and a sixth operation pattern of the distance measurement apparatus 1 in which the scheduled number of times is set to eight will be described. In the same manner as the third operation pattern 803 (see FIG. 9), in the fifth operation pattern and the sixth operation pattern, a read operation on the light receiving section Ci by the control unit 8, and a light emitting operation of the light emitting section Aj (j #i) and a light receiving operation of the light receiving section Cj are allowed to be performed in parallel.

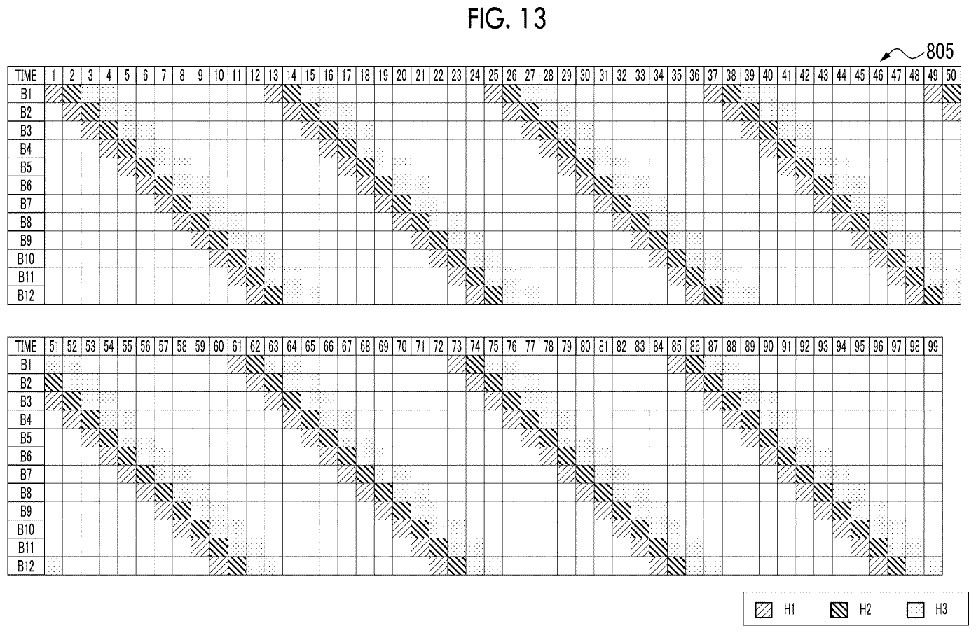

FIG. 13 is a diagram illustrating a fifth operation pattern 805 of the distance measurement apparatus 1 to which the present exemplary embodiment is applied.

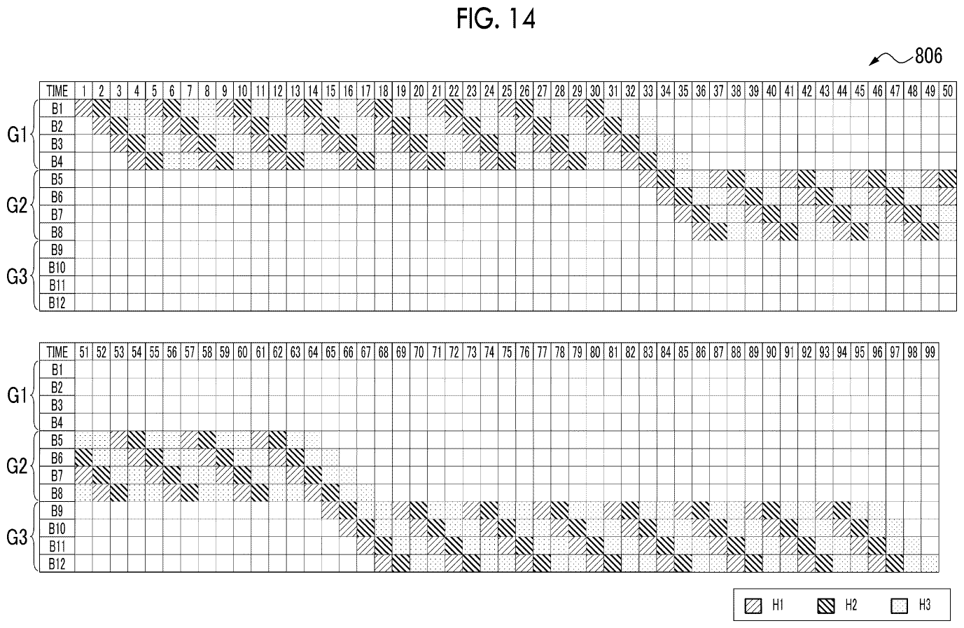

FIG. 14 is a diagram illustrating a sixth operation pattern 806 of the distance measurement apparatus 1 to which the present exemplary embodiment is applied.

As illustrated in FIG. 13, in the fifth operation pattern 805, in the time u=1, the light emitting section A1 corresponding to the irradiation section B1 performs a light emitting operation, and the corresponding light receiving section C1 performs a light receiving operation at the first phase difference φ=0 degrees. Further, in the time u=2, the light emitting section A2 corresponding to the irradiation section B2 performs the light emitting operation and the corresponding light receiving section C2 performs a light receiving operation, in parallel with a read operation on the light receiving section C1 by the control unit 8. This is repeated, in the time u=13, the light emitting section A1 performs the light emitting operation and the light receiving section C1 performs the second light receiving operation at the phase difference φ=0 degrees, in parallel with the read operation on the light receiving section C12 by the control unit 8. Accordingly, the distance measurement apparatus 1 (control unit 8) acquires a result of the first light reception at the phase difference φ=0 degrees in the irradiation sections B1 to B4 and acquires a result of the second light reception at the phase difference φ=0 degrees, and starts the operation related to distance measurement. This is repeated for each phase difference φ, in the time u=97, the scheduled number eight of light emitting operations in the light emitting sections A1 to A12 corresponding to all the irradiation sections B1 to B12, the eight light receiving operations in the corresponding light receiving sections C1 to C12, and the eight read operations on the light receiving sections C1 to C12 by the control unit 8 are completed. Thus, in the fifth operation pattern 805, the distance measurement of all the irradiation sections 61 (B1 to B12) is completed.

As illustrated in FIG. 14, in the same manner as the third operation pattern 803 (see FIG. 9), in the sixth operation pattern 806, the irradiation sections B1 to B4 belong to the group G1, the irradiation sections B5 to B8 belong to the group G2, and the irradiation sections B9 to B12 belong to the group G3, and an operation of distance measurement apparatus 1 is defined based on this grouping. In addition, the light emitting sections A1 to A12 and the light receiving sections C1 to C12 respectively belong to the same group as the corresponding irradiation sections 61.

In the sixth operation pattern 806, in the time u=1, the light emitting section A1 corresponding to the irradiation section B1 performs a light emitting operation, and the corresponding light receiving section C1 performs a first light receiving operation at the phase difference φ=0 degrees. Further, in the time u=2, the light emitting section A2 corresponding to the irradiation section B2 performs the light emitting operation and the corresponding light receiving section C2 performs a light receiving operation, in parallel with a read operation on the light receiving section C1 by the control unit 8. This is repeated, in the time u=5, the light emitting section A1 performs the light emitting operation and the light receiving section C1 performs the second light receiving operation at the phase difference φ=0 degrees, in parallel with the read operation on the light receiving section C4 by the control unit 8. Accordingly, the distance measurement apparatus 1 (control unit 8) acquires a result of the first light reception in the irradiation sections B1 to B4 and acquires a result of the second light reception at the phase difference φ=0 degrees, and starts the operation related to distance measurement. This is repeated, in the time u=33, the scheduled number of eight light emitting operations, light receiving operations, and read operations for all the irradiation sections B1 to B4 belonging to the group G1 are completed, and the operation related to the distance measurement of the group G1 is completed.

Further, in the time u=33, in parallel with the eighth read operation on the light receiving section C4 by the control unit 8, the light emitting section A5 corresponding to the irradiation section B5 performs the light emitting operation and the corresponding light receiving section C5 performs the first light receiving operation, so that an operation related to distance measurement of the group G2 is started. Further, in the same manner as the group G1, the light emitting sections A5 to A8 belonging to the group G2 perform the scheduled number of eight light emitting operations, the light receiving sections C5 to C8 perform the eight light receiving operations, and the control unit 8 performs the eight read operations on the light receiving sections C5 to C8, and in the time u=65, the operation related to the distance measurement of the group G2 is completed. In the same manner, an operation related to the distance measurement of the group G3 is performed in the time u=65 to 97. Thus, in the sixth operation pattern 806, the distance measurement of all the irradiation sections 61 (B1 to B12) is completed.

As illustrated in FIGS. 13 and 14, in the fifth operation pattern 805 and the sixth operation pattern 806, a time until distance measurement of all the irradiation sections 61 is completed is the unit time u×97 (=48.5 ms), and is shorter than the time (84.0 ms) in the operation pattern 701 of the comparative example. In addition, a time until the scheduled number of eight light emitting periods in all the light emitting sections 41 are completed is the unit time u×96 (=48.0 ms), and is shorter than the time (83.5 ms) in the operation pattern 701 of the comparative example. In addition, in the distance measurement apparatus 1 that operates according to the fifth operation pattern 805 or the sixth operation pattern 806, a frame rate of a distance moving image is improved up to 20 fps at a maximum.

In this manner, with the operation pattern according to the present exemplary embodiment, even in a case where the scheduled number of times is increased, it is possible to shorten the time until the scheduled number of light emitting periods in all the light emitting sections 41 are completed. Unlike the fifth operation pattern 805 and the sixth operation pattern 806, even in a case where the read operation on the light receiving section Ci by the control unit 8, and the light emitting operation of the light emitting section Aj (j≠i) and the light receiving operation of the light receiving section Cj are not allowed to be performed in parallel, the operation pattern is set such that the light emitting period of the next light emitting section Aj (j=i+1) is provided in the light non-emitting period of the light emitting section Ai between the light emitting period and the next light emitting period of the light emitting section Ai corresponding to a certain irradiation section Bi, so that it is possible to shorten the time until the scheduled number of light emitting periods in all the light emitting sections 41 are completed.

### Switching of Operation Pattern

The distance measurement apparatus 1 to which the present exemplary embodiment is applied may provide only one of the operation patterns as described above, and may switch between a plurality of operation patterns. For example, the control unit 8 may select one from the plurality of operation patterns based on a user input, a distance measurement history, or the like, and control the operation of the distance measurement apparatus 1 according to the selected operation pattern. In addition, an option of the operation pattern by the control unit 8 may include not only the operation patterns 801 to 806, 802′, and 802″ according to the present exemplary embodiment described above but also an operation pattern to which the present exemplary embodiment is not applied, such as the operation pattern 701 of the comparative example.

In addition, the control unit 8 may select an operation pattern for further improving accuracy of distance measurement based on an evaluation value obtained by evaluating the accuracy of distance measurement of the target object S from the results of distance measurement in each of the plurality of operation patterns.

### Distance Measurement Apparatus 1, Light Emitting Apparatus 2, and Drive Device 9

The distance measurement apparatus 1 that operates according to the operation patterns 801 to 806, 802′, and 802″ described above is an example of a distance measurement apparatus including a drive unit that drives a light emitting unit such that a second light emitting section has a light emitting period in a light non-emitting period during which a first light emitting section does not emit light between a light emitting period and the next light emitting period of the first light emitting section.

Further, as illustrated by a broken line in FIG. 1, the light emitting apparatus 2 can be configured with the light emitting unit 4, the light emission drive unit 6, and the control unit 8. In other words, the light emitting apparatus 2 can be configured to cause the light emitting unit 4 to emit light according to the operation patterns 801 to 806, 802′, and 802″. The light emitting apparatus 2 is an example of a light emitting apparatus including a drive unit that drives a light emitting unit such that a second light emitting section has a light emitting period in a light non-emitting period during which a first light emitting section does not emit light, between a light emitting period and the next light emitting period of the first light emitting section.

Further, as illustrated by the one-dot chain line in FIG. 1, a drive device 9 can be configured with the light emission drive unit 6 and the control unit 8 to drive the light emitting unit 4 (an example of a light emitting device). In other words, the drive device 9 can be configured to drive the light emitting unit 4 such that the light emitting unit 4 emits light according to the operation patterns 801 to 806, 802′, and 802″. The drive device 9 is an example of a drive device that drives a light emitting device such that a second light emitting section has a light emitting period during a light non-emitting period during which a first light emitting section does not emit light between a light emitting period and the next light emitting period of the first light emitting section.

### Supplementary Notes

(((1)))

A drive device that drives a light emitting device including a first light emitting section and a second light emitting section,
wherein each of the first light emitting section and the second light emitting section has a predetermined plurality of light emitting periods, and
the drive device is configured to:
   cause the light emitting device to perform pulse light emission 500 times or more in the light emitting period; and
   drive the light emitting device such that the second light emitting section has a light emitting period in a light non-emitting period during which the first light emitting section does not emit light between a light emitting period and a next light emitting period of the first light emitting section.
      (((2)))

The drive device according to (((1))),
wherein the light emitting device is driven such that with respect to one light emitting section group including the first light emitting section and the second light emitting section included in the light emitting device, and another light emitting section group including another light emitting section, after the predetermined plurality of light emitting periods of the one light emitting section group, the other light emitting section group has a light emitting period.
   (((3)))

The drive device according to (((2))),
wherein the light emitting device is driven such that light emitting sections belonging to the one light emitting section group are adjacent to each other.
   (((4)))

The drive device according to (((1))),
wherein the light non-emitting period is defined by the number of times of unit time, by using a time corresponding to the light emitting period as the unit time, and
with respect to one light emitting section group including the first light emitting section and the second light emitting section included in the light emitting device, and another light emitting section group including another light emitting section, the number of light emitting sections belonging to the one light emitting section group coincides with the number of times of unit time defined as the light non-emitting period.
   (((5))

The drive device according to any one of (((1))) to (((4))),
wherein the light emitting device is driven such that a light emitting period of a third light emitting section that is not adjacent to the first light emitting section included in the light emitting device overlaps with the light emitting period of the first light emitting section.
   (((6)))

A distance measurement apparatus comprising:
a light emitting unit that includes a first light emitting section and a second light emitting section;
a drive unit that drives the light emitting unit such that each of the first light emitting section and the second light emitting section has a predetermined plurality of light emitting periods;
a light receiving unit that receives light emitted from the light emitting unit and reflected by a target object; and
a calculation unit that calculates a distance to the target object based on a result of light reception by the light receiving unit,
wherein the drive unit drives the light emitting unit such that the second light emitting section has a light emitting period in a light non-emitting period during which the first light emitting section does not emit light between a light emitting period and a next light emitting period of the first light emitting section.
   (((7)))

The distance measurement apparatus according to (((6))),
wherein the light emitting unit includes one light emitting section group including the first light emitting section and the second light emitting section, and another light emitting section group including another light emitting section, and
after all light emitting sections belonging to the one light emitting section group complete a light emitting period once, the calculation unit acquires a result of light reception by the light receiving unit from a start of the light emitting period of the light emitting section at a head to an end of the light emitting period of the light emitting section at a tail in the one light emitting section group.
   (((8)))

The distance measurement apparatus according to (((6))),
wherein the light receiving unit includes a first light receiving section that receives the light reflected by the target object in the light emitting period of the first light emitting section, and a second light receiving section that receives the light reflected by the target object in the light emitting period of the second light emitting section, and
the calculation unit acquires a result of the light reception for each light receiving section included in the light receiving unit.
   (((9)))

The distance measurement apparatus according to (((8))),
wherein the drive unit drives the light emitting unit such that the second light emitting section has the light emitting period in a period during which the calculation unit acquires a result of light reception in the first light receiving section.
   (((10)))

A light emitting apparatus comprising:
a light emitting unit that includes a first light emitting section and a second light emitting section; and
a drive unit that drives the light emitting unit such that each of the first light emitting section and the second light emitting section has a predetermined plurality of predetermined light emitting periods,
wherein the drive unit is configured to:
   cause the light emitting unit to perform pulse light emission 500 times or more in the light emitting period; and
   drive the light emitting unit such that the second light emitting section has a light emitting period in a light non-emitting period during which the first light emitting section does not emit light between a light emitting period and a next light emitting period of the first light emitting section.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A drive device that drives a light emitting device including a first light emitting section and a second light emitting section,
wherein each of the first light emitting section and the second light emitting section has a predetermined plurality of light emitting periods, and
the drive device is configured to:
cause the light emitting device to perform pulse light emission 500 times or more in the light emitting period; and
drive the light emitting device such that the second light emitting section has a light emitting period in a light non-emitting period during which the first light emitting section does not emit light between a light emitting period and a next light emitting period of the first light emitting section.

2. The drive device according to claim 1,
wherein the light emitting device is driven such that with respect to one light emitting section group including the first light emitting section and the second light emitting section included in the light emitting device, and another light emitting section group including another light emitting section, after the predetermined plurality of light emitting periods of the one light emitting section group, the other light emitting section group has a light emitting period.

3. The drive device according to claim 2,
wherein the light emitting device is driven such that light emitting sections belonging to the one light emitting section group are adjacent to each other.

4. The drive device according to claim 1,
wherein the light non-emitting period is defined by the number of times of unit time, by using a time corresponding to the light emitting period as the unit time, and
with respect to one light emitting section group including the first light emitting section and the second light emitting section included in the light emitting device, and another light emitting section group including another light emitting section, the number of light emitting sections belonging to the one light emitting section group coincides with the number of times of unit time defined as the light non-emitting period.

5. The drive device according to claim 1,
wherein the light emitting device is driven such that a light emitting period of a third light emitting section that is not adjacent to the first light emitting section included in the light emitting device overlaps with the light emitting period of the first light emitting section.

6. A distance measurement apparatus comprising:
a light emitting unit that includes a first light emitting section and a second light emitting section;
a drive unit that drives the light emitting unit such that each of the first light emitting section and the second light emitting section has a predetermined plurality of light emitting periods;
a light receiving unit that receives light emitted from the light emitting unit and reflected by a target object; and
a calculation unit that calculates a distance to the target object based on a result of light reception by the light receiving unit,
wherein the drive unit drives the light emitting unit such that the second light emitting section has a light emitting period in a light non-emitting period during which the first light emitting section does not emit light between a light emitting period and a next light emitting period of the first light emitting section.

7. The distance measurement apparatus according to claim 6,
wherein the light emitting unit includes one light emitting section group including the first light emitting section and the second light emitting section, and another light emitting section group including another light emitting section, and
after all light emitting sections belonging to the one light emitting section group complete a light emitting period once, the calculation unit acquires a result of light reception by the light receiving unit from a start of the light emitting period of the light emitting section at a head to an end of the light emitting period of the light emitting section at a tail in the one light emitting section group.

8. The distance measurement apparatus according to claim 6,
wherein the light receiving unit includes a first light receiving section that receives the light reflected by the target object in the light emitting period of the first light emitting section, and a second light receiving section that receives the light reflected by the target object in the light emitting period of the second light emitting section, and
the calculation unit acquires a result of the light reception for each light receiving section included in the light receiving unit.

9. The distance measurement apparatus according to claim 8,
wherein the drive unit drives the light emitting unit such that the second light emitting section has the light emitting period in a period during which the calculation unit acquires a result of light reception in the first light receiving section.

10. A light emitting apparatus comprising:
a light emitting unit that includes a first light emitting section and a second light emitting section; and
a drive unit that drives the light emitting unit such that each of the first light emitting section and the second light emitting section has a predetermined plurality of predetermined light emitting periods,
wherein the drive unit is configured to:
cause the light emitting unit to perform pulse light emission 500 times or more in the light emitting period; and
drive the light emitting unit such that the second light emitting section has a light emitting period in a light non-emitting period during which the first light emitting section does not emit light between a light emitting period and a next light emitting period of the first light emitting section.
